(19) United States
(12) Patent Application Publication
(10) Pub. No.: US 2025/0356220 A1
(43) Pub. Date: Nov. 20, 2025

(54) SYSTEMS AND METHODS FOR ENHANCED MACHINE LEARNING TECHNIQUES FOR KNOWLEDGE MAP GENERATION AND USER INTERFACE PRESENTATION

(71) Applicant: Unified Intelligence, Inc., Westlake, OH (US)

(72) Inventor: Gang Tian, Westlake, OH (US)

(21) Appl. No.: 19/208,455

(22) Filed: May 14, 2025

Related U.S. Application Data
(60) Provisional application No. 63/647,981, filed on May 15, 2024.

(51) Int. Cl. G06N 5/02; G06F 9/451

(52) U.S. Cl. CPC G06N 5/02; G06F 9/452

(57) ABSTRACT

Systems and methods for extracting information from documents and constructing corresponding knowledge maps with respect to defined knowledge models. Deep-learning-based models for Natural Language Processing (NLP) are applied to tokenize words, tag, parse, and lemmatize sentences of input documents. Then an information extractor traverses the dependency tree of NLP object to recursively extract the entities of interest to the knowledge models. Finally, a knowledge map constructor traverses the dependency tree of NLP object to determine the relationships among the extracted entities and construct knowledge maps recursively following the defined knowledge models.

### CROSS-REFERENCE TO RELATED APPLICATIONS

This application claims priority to U.S. Prov. Patent App. No. 63/647,981 titled “SYSTEMS AND METHODS FOR ENHANCED MACHINE LEARNING TECHNIQUES FOR KNOWLEDGE MAP GENERATION AND USER INTERFACE PRESENTATION” and filed on May 15, 2024, the disclosure of which is hereby incorporated herein by reference in its entirety.

### BACKGROUND

### Technical Field

The present disclosure relates to machine learning models, and more particularly, to machine learning models for knowledge extraction.

### Description of Related Art

Manufacturing is the process of turning raw materials or parts into finished goods using tools, human labor, machinery, and chemical processing. For a finished product, its manufacturing process depends on the materials as well as the applied technologies and the configured machines. Process flow charts, operation procedures, and device configuration diagrams are created to capture the information of a manufacturing process. A manufacturing process flow chart is a set of separate steps in sequential order. The function of each step is to convert the input materials into the output materials physically or chemically. Each step can be completed in a single device or in a setup of multiple connected devices. Operators follow Standard Operating Procedures (SOP) to control devices, complete process steps and turn the input materials into intermediate materials, and eventually into final products. Operation procedures typically include all the details of the process, including the input material specifications, device configurations, and a serial of interactions between the operators and the devices.

Manufacturing Process Management (MPM) is a sophisticated task, involving design, simulation, resource planning, quality assurance, operation management, and so on. Various software/solutions are developed to provide services covering different aspects of MPM, including Enterprise resource planning (ERP), Quality Management System (QMS), simulation platforms, etc. These software solutions can be interconnected with each other through web services or APIs. However, the interconnections are limited to the scope and interfaces specific to each individual service. The interconnections facilitate information exchange, but not knowledge inheritance. Techniques to map an innovation concept from the original idea to final product across the different phases of product life cycle are challenging. For example, process examples described in a patent application document may typically be device-independent and expressed in passive voice, while SOPs for manufacturing involves specific machine operations and are usually presented in active voice without subjects.

The breakthroughs in artificial intelligence (AI) and natural language processing (NLP) provide new tools to businesses and organizations across industries. However, it is considered an AI-hard problem to have machines understand and tell the differences between two similar ideas or methods described in documents or simulation models. Currently, human expert reading is needed to make precise comparison between two documents of high similarity score. Additionally, current AI-based techniques are not well-suited to extracting the knowledge, or information, in textual documents.

### SUMMARY

Example aspects of the present disclosure relate to a method, system, and computer storage media, which performs actions. The actions include obtaining a textual portion to be analyzed, the textual portion being associated with process; accessing a dependency tree associated with the textual portion, the dependency tree being generated via a forward pass through a natural language processing (NLP) model, and the dependency tree organizing the textual portion into nodes connected via connections, wherein individual nodes are associated with individual tokens reflected in the textual portion; generating one or more knowledge maps based on the dependency tree, wherein the knowledge maps organize the process into individual processes and individual materials, wherein entities are extracted based on the tokens, and wherein relationship information is used to relate the extracted entities to form the knowledge maps; and causing presentation, via an interactive user interface, of at least a portion of the one or more knowledge maps.

Example aspects of the present disclosure relate to a method, system, and computer storage media, which performs actions. The actions include accessing a textual portion, the textual portion reflecting a plurality of processes; obtaining a dependency tree based on the textual portion, the dependency tree being generated via a forward pass through a natural language processing (NLP) model, and the dependency tree organizing the textual portion into nodes connected via connections; updating the dependency tree to form an information tree, wherein individual nodes of the information tree are assigned a particular entity classification of a plurality of entity classifications; and generating one or more knowledge maps based on the information tree.

Example aspects of the present disclosure relate to a method, system, and computer storage media, which performs actions. The actions include accessing a dependency tree associated with a textual portion; determining an information tree based on the dependency tree, the information tree recognizing entities in the textual portion and removing one or more nodes of the dependency tree which have a particular type of connection; and generating one or more knowledge maps based on the information tree, the knowledge maps including one or more of: a first knowledge map which includes text of the textual portion organized into operation procedures, a second knowledge map which includes nodes reflecting processes described in the textual portion connected to nodes reflecting materials associated with the processes, or a third knowledge map which graphically depicts device configuration information associated with the processes.

Example aspects of the present disclosure relate to a method, system, and computer storage media, which performs actions. The actions include obtaining an input textual portion; generating, for presentation via a user device, an interactive user interface, wherein the interactive user interface: presents a first knowledge map which includes text of the textual portion organized into operation procedures, presents a second knowledge map which includes nodes reflecting processes described in the textual portion connected to nodes reflecting materials associated with the processes, and/or presents a third knowledge map which graphically depicts device configuration information associated with the processes.

### BRIEF DESCRIPTION OF THE DRAWINGS

FIG. 1A is a block diagram of an example knowledge extraction system determining a knowledge map based on a received document.

FIG. 1B is a block diagram illustrating detail of the knowledge extraction system determining a knowledge map.

FIG. 2 is a graphical illustration of an example knowledge map determined based on an input textual portion.

FIG. 3 is a flowchart of an example process to determine a knowledge map based on an obtained textual portion.

FIG. 4A is a flowchart of an example process to generate an information tree based on a dependency tree.

FIG. 4B illustrates dependency tags organized into different groups and used by the knowledge extraction system to generate the information tree.

FIG. 4C illustrates an example of adjusting a portion of a dependency tree as part of a process to generate an information tree.

FIG. 5 illustrates generating one or more knowledge maps based on an information tree and relationship information associated with nodes of the information tree.

FIG. 6A illustrates an example dependency tree.

FIG. 6B illustrates an example information tree determined based on the example dependency tree.

FIG. 6C illustrates example knowledge map(s) determined based on the example information tree.

FIG. 6D illustrates example knowledge map(s) which include operation procedure, process, and device configuration nodes.

FIG. 7 illustrates the knowledge extraction system presenting a user interface associated with updating a manual.

FIG. 8A illustrates an example user interface that includes summary information associated with updating manuals.

FIG. 8B illustrates an example user interface that includes tasks for completion by a user of the user interface.

FIG. 8C illustrates an example user interface that includes a first portion of a document as analyzed according to the techniques described herein.

FIG. 8D illustrates the example user interface as including a second portion of the document with identified changes made since a prior version of the document.

FIG. 8E illustrates an example user interface that includes detail associated with a task to update knowledge map(s) generated based on the document.

FIG. 8F illustrates an example user interface that allows the user to accept or reject the task.

FIG. 8G illustrates an example user interface that includes a summary of updates to be made based on the second portion of the document.

FIG. 8H illustrates an example dependency tree and information tree.

FIG. 9A illustrates an example user interface reflecting manuals to be updated based on detected changes.

FIG. 9B illustrates summary information associated with a selected manual.

FIG. 9C illustrates summaries of changes associated with a new version of a document along with suggestions to update the selected manual.

FIG. 9D illustrates detail associated with specific tasks to update the selected manual.

FIG. 9E illustrates specific changes to be made to the selected manual based on a selected task.

FIG. 10 is a flowchart of an example process for effectuating changes to a manual associated with a document.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction—Summary

The disclosed technology relates to techniques to extract, and organize, information from structured or unstructured text. Example text may include documents, manufacturing processes, chemical processes, manuals, governmental regulations, requirement documents, design documents, operation procedures, patents, and so on.

With respect to the example of a manufacturing process, the associated text may include complex descriptions identifying specific steps to be performed in specific sequences. At present, such text requires professionals to parse through the text and understand the specific steps. In contrast, using the techniques described herein a system may output succinct, and easy-to-understand, information that summarizes text while preserving all, or some, of the relevant information in the text.

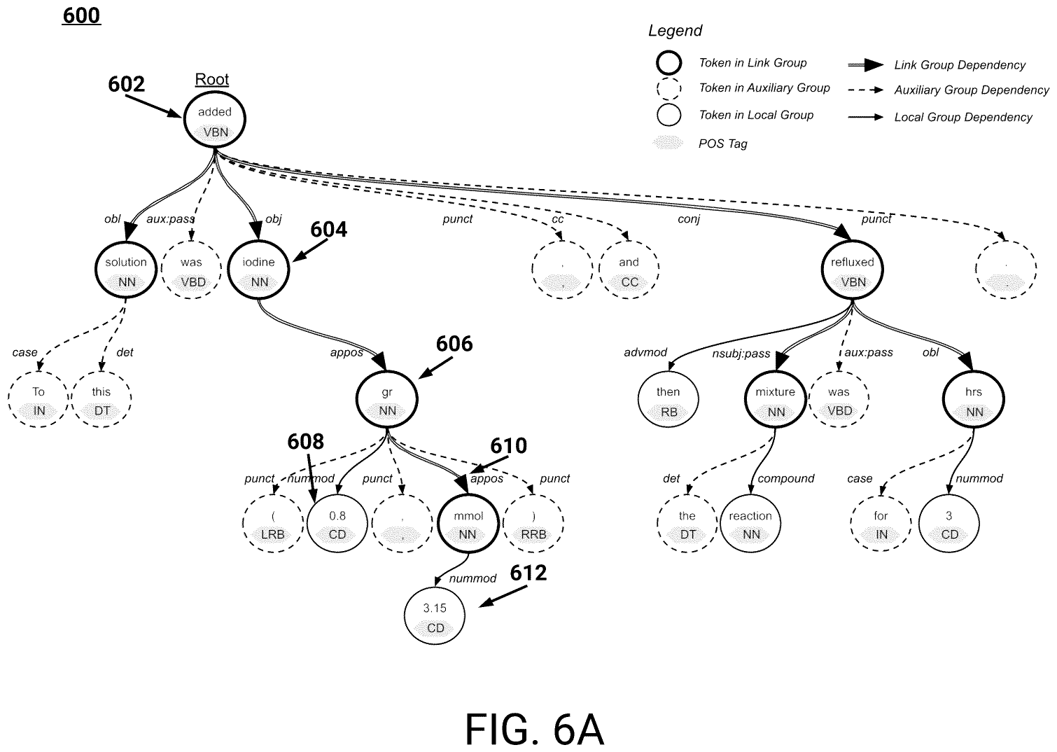

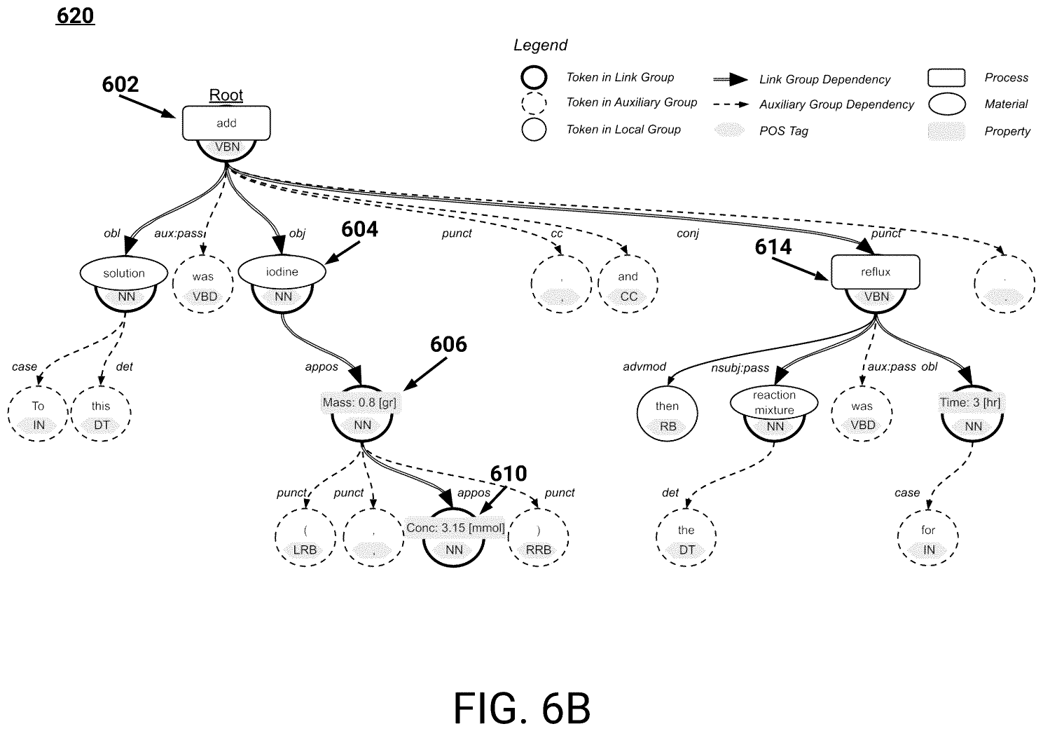

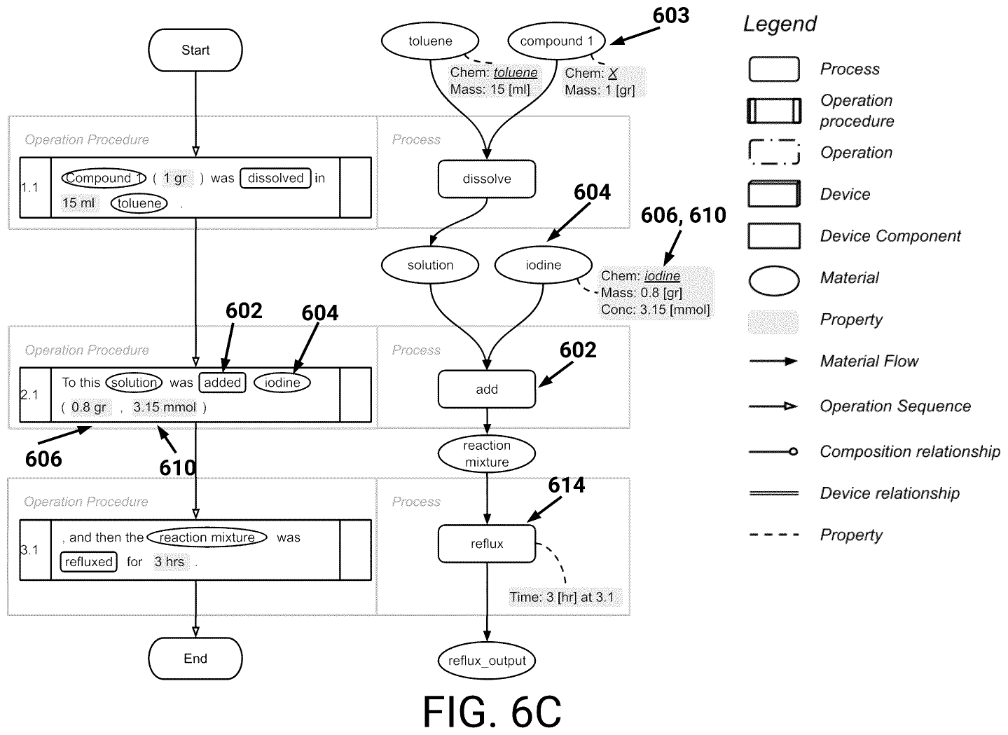

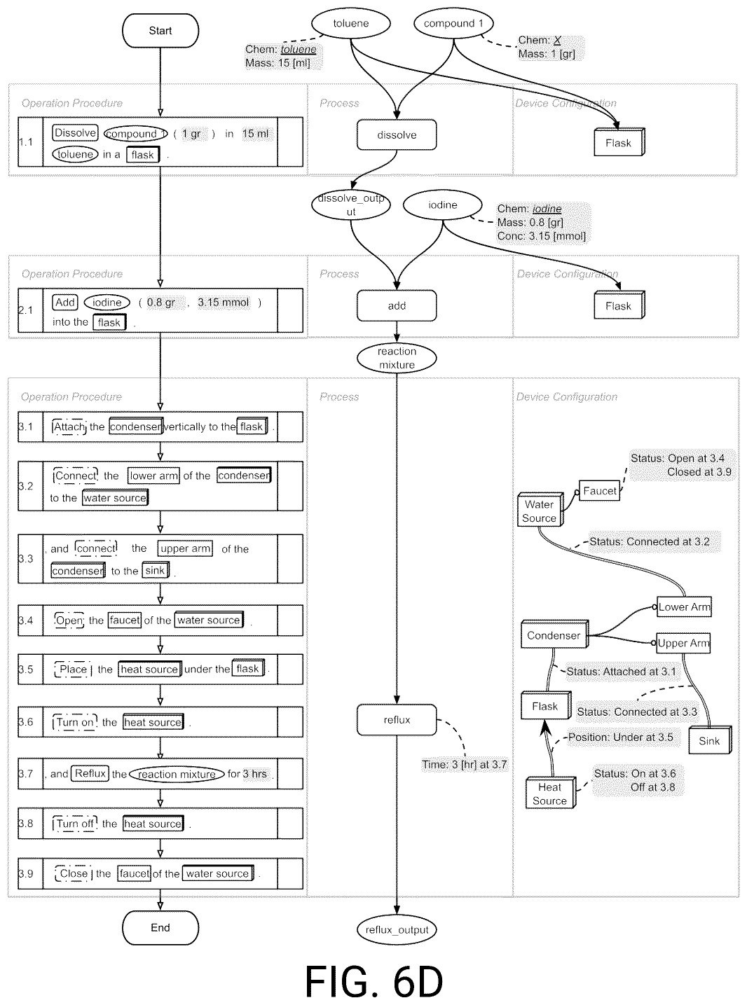

Specifically, the output may represent a knowledge map which characterizes the text as entities with specific relationships between the entities. For example, the entities may represent words recognized via machine learning, or rule-based techniques, which are relevant to a knowledge domain. As an example, entities may relate to specific process terms, material terms, device terms, and so on. The entities may be related to inform the specific processes, operations, and so on which are described in input text. For example, input text associated with chemical manufacturing may describe specific actions to be performed using disparate materials. In this example, the entities may describe an action (e.g., combine, add, mix), a material (e.g., solution, iodine, reaction mixture), and so on, and the knowledge map may relate them. Example knowledge maps are included in FIG. 6C and FIG. 6D.

Advantageously, such knowledge maps may be graphically presented to an end-user or, in some embodiments, may be provided to a system configured to perform a manufacturing process. For example, and with respect to FIG. 6D, a user may view a succinct overview of information included in a portion of text. In this example, the user may view text organized into different operations (e.g., on the left-side), the specific processes (e.g., in the middle), and the device configurations (e.g., on the right-side). Thus, complex textual portions may be converted into knowledge maps which allow for an easy-to-understand view of the information included in the textual portions.

As will be described, a system may leverage a natural language processing (NLP) model to process received text. For example, the NLP model may output a dependency tree which characterizes the dependencies between words, grammatical elements, and so on of input text. In this example, the NLP model may be trained to output information which the system may use to generate the knowledge map described herein.

Advantageously, the system may use specific rules, disparate domain information, and so on to inform the above-described knowledge map generation. In contrast, other natural language processing techniques may rely upon generative techniques, for example, large language models. These models are inefficient in terms of processing and are prone to inaccuracies introduced through the generative aspect of the model (e.g., hallucinations). Thus, the techniques described herein ensure efficient, and accurate, characterization of text into knowledge maps without the technical problems associated with generative techniques.

### Introduction—Knowledge Map(s)

As described above, the disclosed techniques may apply natural language processing (NLP) machine learning models (e.g., deep-learning models) or rule-based processes. Example NLP models are known by those skilled in the art and may be used for the techniques described herein. With respect to an NLP model, the NLP model may output NLP objects which include grammatical structures of the sentences, the dependency relationship between words, and lemma of each word for an input document. In some embodiments, and as illustrated in FIG. 6A, this information may be included in a dependency tree. The NLP model can be based on transformer, convolutional neural network, or any other technologies. The disclosed technology is not limited to any specific order of the NLP models. The NLP models process input text continuously on the base of phrases, sentences, or paragraphs.

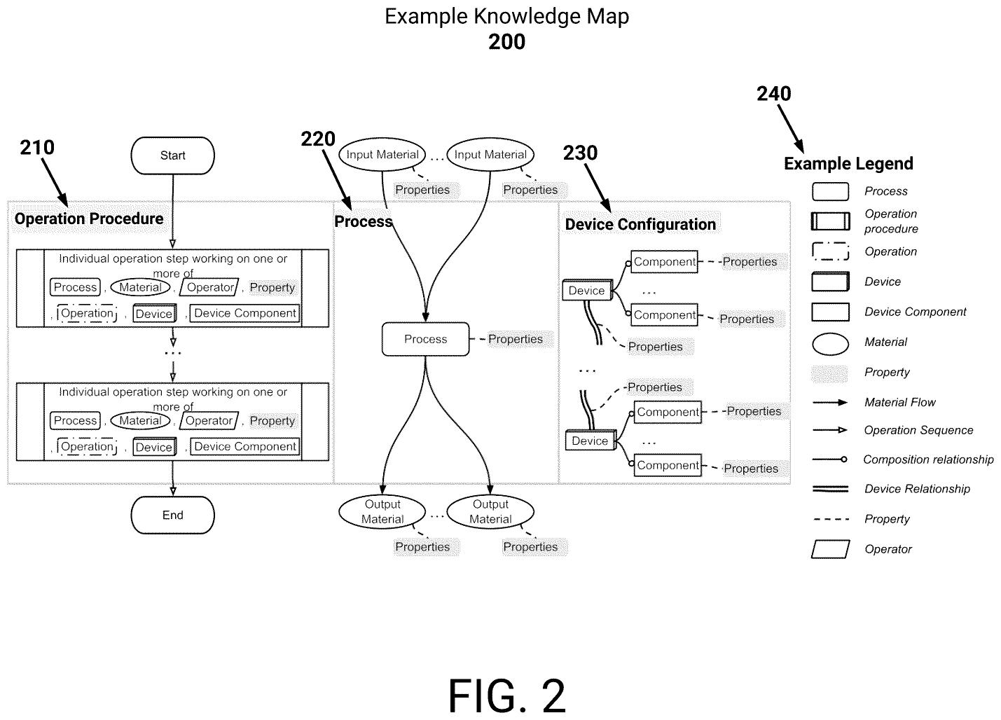

In some embodiments, and as described in FIG. 2, the dependency tree may characterize nodes, and connections between nodes, using different types of groups. These different types of groups may be user-definable, and the NLP model may be trained to perform the characterization. As an example, the dependency tree may include a link group which describes relationships between parent and child objects. The dependency information may further include an auxiliary group which facilitate recognition of a relationship between a parent and child object. The dependency information may further include a local group that describes a contribution to the expression or property of a parent object. As will be described, the local group may be used to characterize, or supplement, the parent object.

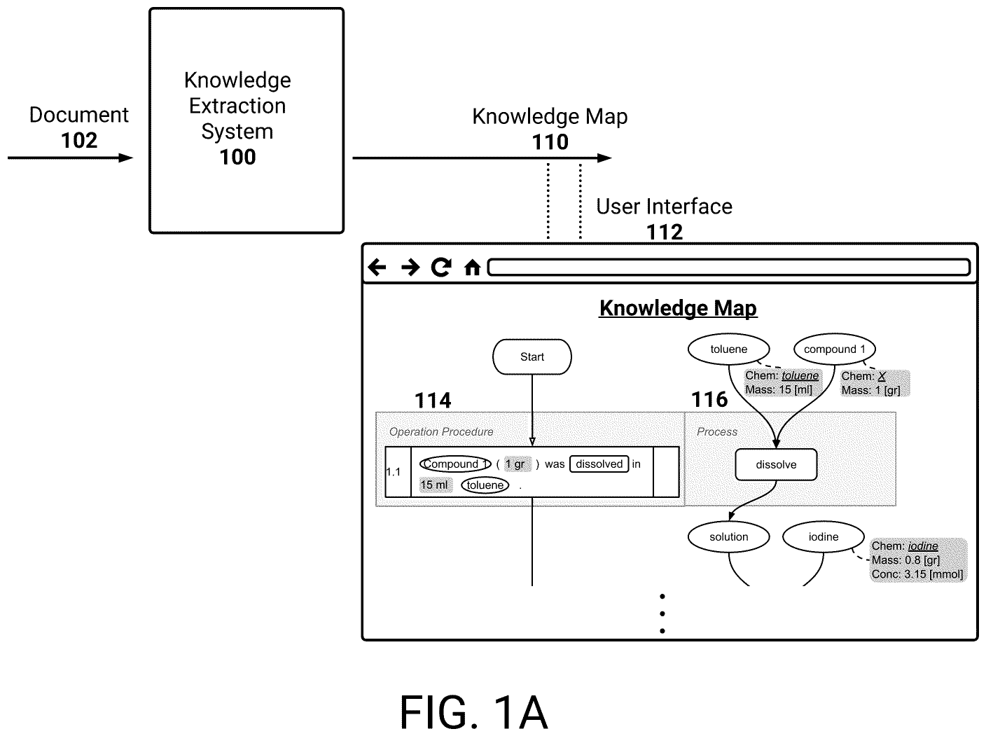

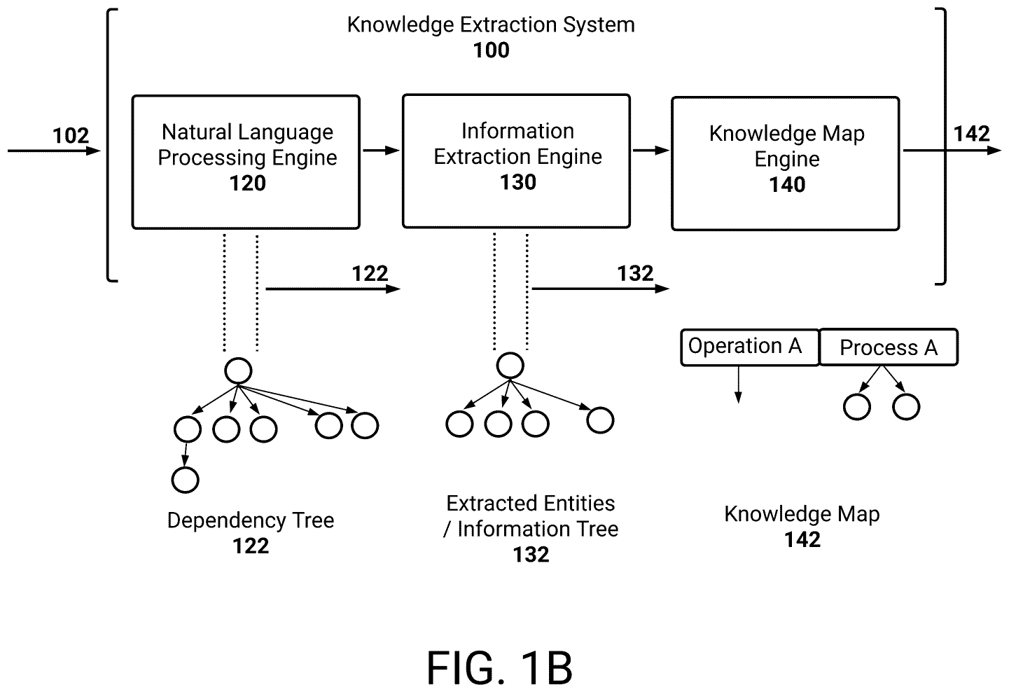

Based on the dependency tree, an information tree may be determined which extracts entities of interest based on a knowledge model. For example, and as illustrated in FIG. 1B, the system described herein may execute an information extraction engine to generate the information tree. As an example with respect to chemical processes, and as illustrated in FIG. 6B, the system may characterize the objects as being different types of information (e.g., process, material, property, and so on). For this example, the system may leverage specific knowledge domain which is usable to perform the characterization. The system may optionally deduplicate names of these objects, for example, using the above-described NLP model to ensure that different names may correspond to the same object.

In some embodiments, the above-described information tree may be determined from the NLP objects in a recursive manner via traversing the dependency tree (e.g., traversing from parent to child). In some embodiments, the dependency tree may be specific to a subset of input text (e.g., a sentence, multiple sentences, a paragraph, a sub-heading, and so on). To extract entities, an NLP named entity recognition model may be used and/or a rule-based technique. As known by those skilled in the art, the NLP model may be based on transformer, convolutional neural network, recurrent neural network, dense networks, or any other technologies.

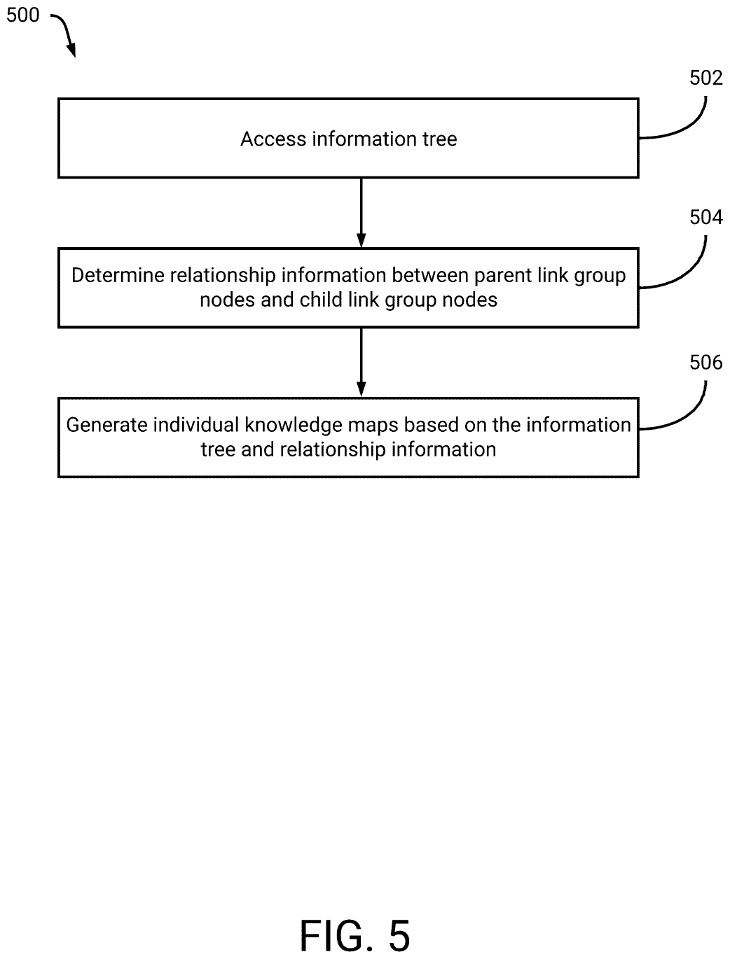

To determine a knowledge map, such as described in FIG. 5, relationships among the extracted entities may be determined. In some implementations, and as described above, subsets of text are processed individually to determine individual dependency trees. In these implementations interconnected knowledge maps may be constructed with respect to knowledge models via traversing the information tree of each subset. Relationship information may be determined using an NLP model and/or rule-based technique.

As will be described, the knowledge map may describe different aspects of information included in a portion of text. For example, a knowledge map may summarize the process steps described in the portion of text. In this example, and with respect to chemical manufacturing, the process steps may include actions (e.g., add, reflux) along with inputs, outputs, and so on. As another example, a knowledge map may include operation procedure information which may characterize words included in the portion of text. For this example, and as illustrated in FIG. 6A, portions of the input text may be assigned as different classifications (e.g., operations, materials, devices used and characteristics thereof, and so on). As another example, a knowledge map may include device configuration information. For this example, and with respect to the example of chemical manufacturing, the knowledge map may describe specific device configurations which are to occur. As an example, connections between different devices may be described. As another example, actions to be performed using devices may be described (e.g., a material may be input into a specific device).

Advantageously, such knowledge maps may be graphically presented to an end-user or, in some embodiments, may be provided to a system configured to perform a manufacturing process. For example, and with respect to FIG. 6D, a user may view a succinct overview of information included in a portion of text. In this example, the user may view text organized into different operations (e.g., on the left-side), the specific processes (e.g., in the middle), and the device configurations (e.g., on the right-side). Thus, complex textual portions may be converted into knowledge maps which allow for an easy-to-understand view of the information included in the textual portions.

The above, and other, features will now be described in more detail.

### Block Diagrams

FIG. 1A is a block diagram of an example knowledge extraction system 100 generating a knowledge map 110 based on a received document 102. The knowledge extraction system 100 may represent a system of one or more processors, one or more computers, one or more virtual machines executing on a system, and so on. In some embodiments, the knowledge extraction system 100 may represent a user device which is executing an application. Example user devices may include a wearable device, a laptop, a tablet, and so on. In some embodiments, the knowledge extraction system 100 may represent a server, or back-end system, which determines knowledge maps. For example, the system 100 may be associated with a web application in which a user may provide a document 102 for analysis. The system 100 may also respond to application programming interface (API) calls or endpoints to analyze documents.

As described herein, the knowledge extraction system 100 may analyze received documents (e.g., document 102) and generate knowledge map(s) 110 based on the document 102. A document may represent a textual portion, such as a manual, chemical manufacturing process, and so on as described herein. The document 102 may be in a markup language format, such as XML, HTML, and so on. The document 102 may also not be in a structured format. In some embodiments, the document 102 may analyzed (e.g., parsed) such as via object character recognition techniques to obtain a structure document.

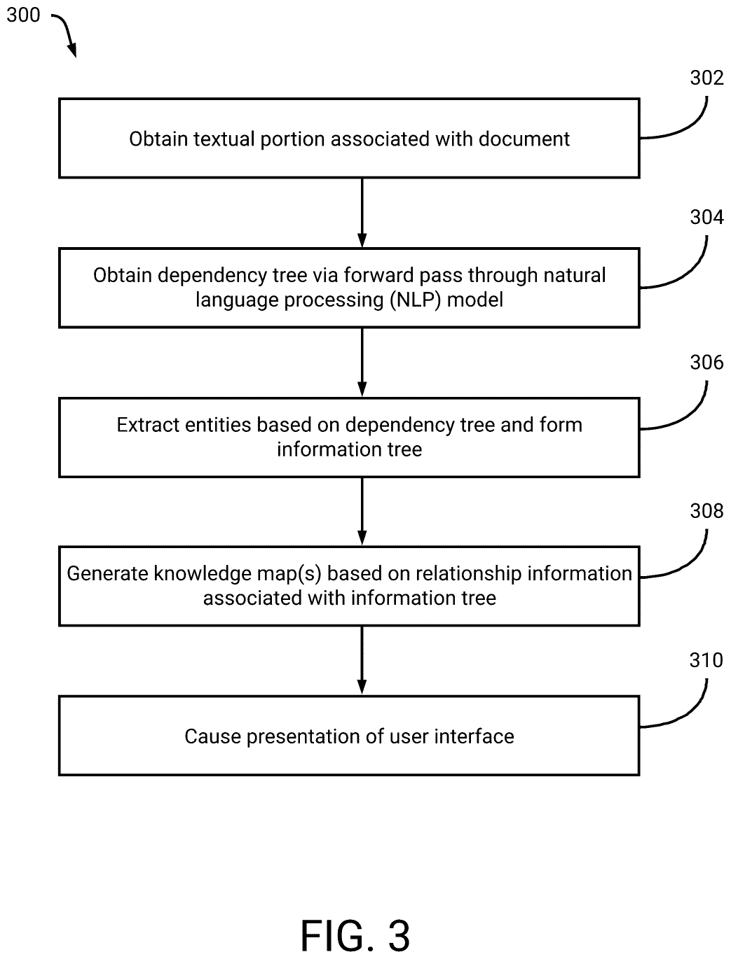

As may be appreciated, the document 102 may be organized into different portions such as headings, sub-headings, and so on. In some embodiments, the knowledge extraction system 100 may individually analyze these portions and optionally combine the analysis to form the knowledge map(s) 110. For example, the document title may represent a root element of structured document, with the headings, numbered/bulleted items, text/paragraphs, tables, figures, and other document elements representing children of the root. In some embodiments, the system 100 may recursively process the document 102 from the parent to the children. As an example, the system may start at the title, traverse to a child node (e.g., a sub-heading) and process the child node to extract knowledge information from the child node. Example knowledge information may include the text included in the child node tagged, or otherwise characterized, according to a classification scheme. Example knowledge information may additionally include a knowledge map. Extracting knowledge information is described in more detail below with respect to at least FIG. 3. Thus, the process described in FIG. 3 may be recursively performed in some embodiments.

As described above, a knowledge map 110 may preserve information included in the document 102 with the knowledge map 110 optionally being specific to a particular knowledge domain. To determine the knowledge map 110, one or more knowledge domain models may be used to inform the entities which relevant to the domain, relationships between the entities, and so on. For example, a manufacturing knowledge domain model may preserve information described in manufacturing process documents. As another example, a chemical process knowledge domain may preserve information described in a chemical processing document.

In some embodiments, the knowledge extraction system 100 may select one or more knowledge domain models. For example, the system 100 may analyze the document 102 to determine the appropriate models. In this example, the system 100 may execute a machine learning model which classifies the document 102 as corresponding to one or more knowledge domain models. The system 100 may also analyze the document 102 via identifying terms which are typically associated with a particular knowledge domain model. These knowledge domain models may be associated with NLP models and/or rule-based techniques to extract entities, determine relationships, and so on. For example, a first NLP model may be used for manufacturing while a second NLP model may be used for chemical processing. Thus, the system 100 may select a particular NLP model based on the knowledge domain model. As another example, a same NLP model may be used for all knowledge domains.

As described herein, the knowledge map 110 preserve information which may be spread throughout the document 102 and converts it into a form easily-digestible, sharable, and so on, by a user. For example, the system 100 may characterize entities included in the document 102 according to a classification which may be based on a knowledge domain model. An entity, as described herein, may refer to a word which is to be preserved in the knowledge map 110. Example entity classifications are included below with respect to Tables 1-3.

With respect to a manufacturing process, the classification may include one or more of a process, an operation procedure, an operation, a device, a device component, a material, a property, and so on. The knowledge map 110 may use these classifications of entities, and relationships between the entities, to generate succinct information from the document 102. For example, the knowledge map 110 may be included in a user interface 112 accessible to a user. In the illustrated embodiment, the user interface 112 includes a left-portion 114 which includes a portion of text from the document 102. This portion of text includes, ‘Compound 1 (1 gram) was dissolved in 15 ml toluene.’ As illustrated, the words of the text are graphically adjusted. While an example classification scheme is described below with respect to FIG. 2, by way of example the adjustment of Compound 1 and toluene may represent a ‘material’ classification and the adjustment of ‘dissolved’ may represent a process step. The right-portion 116 includes a graphical representation of process steps. For example, ‘dissolve’ is included a process step with materials above it representing the input and materials below it representing the output. Thus, in some embodiments the information from the left-portion 114 may represent the underlying knowledge information which is used to generate the right-portion 116.

FIG. 1B is a block diagram illustrating detail of the knowledge extraction system 100 determining a knowledge map 142. The knowledge extraction system 100 includes a natural language processing (NLP) engine 120 which may be trained to output a dependency tree 122 associated with input text (e.g., document 102). While an NLP engine is described, in some embodiments a rule-based engine may be used. The knowledge extraction system 100 further includes an information extraction engine 130 which determines an information tree 132 based on the dependency tree 122. The knowledge extraction system 100 further includes a knowledge map engine 140 which then outputs the knowledge map 142.

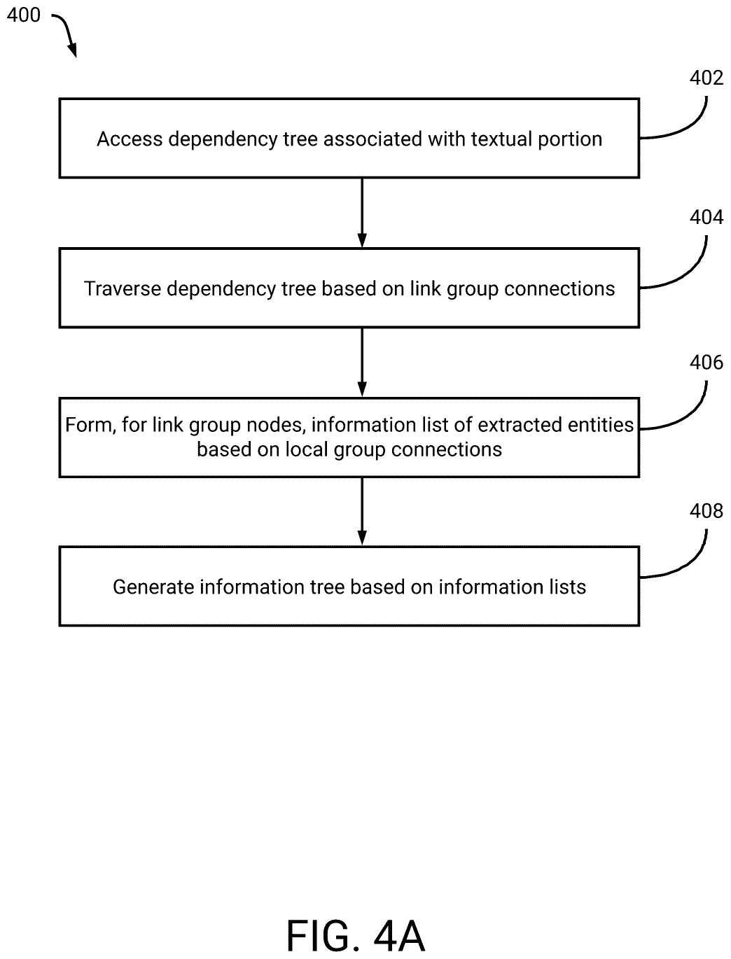

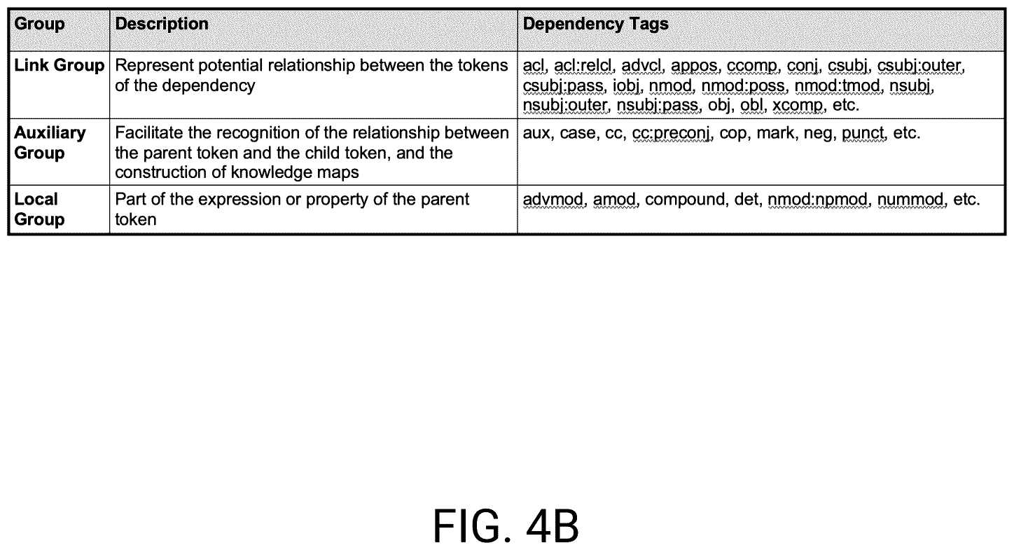

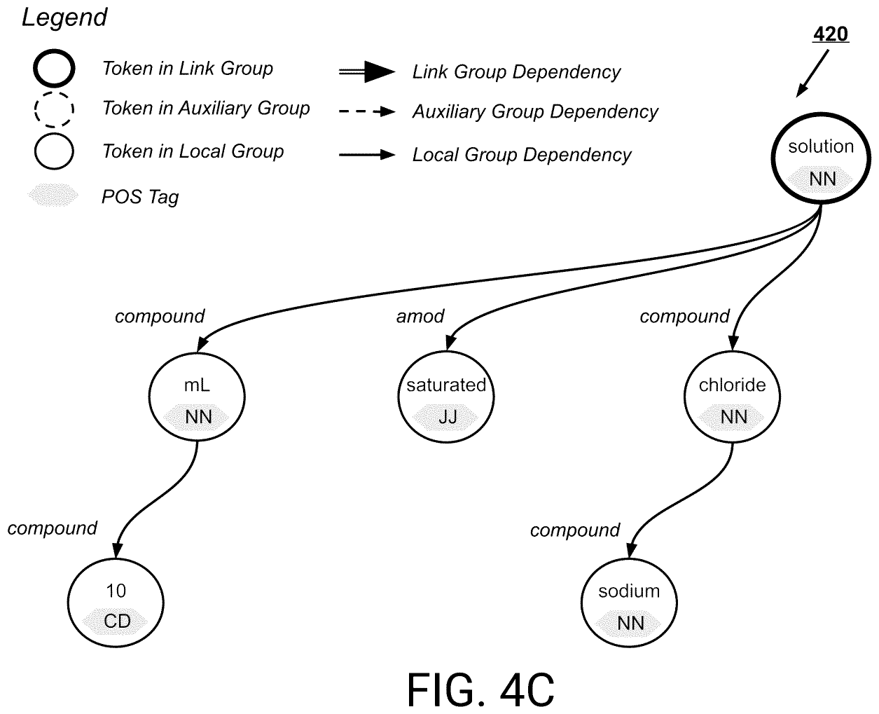

The NLP engine 120 may represent a model which enables processing of text. For example, the engine 120 may include a tokenizer which adjusts the text into tokens (e.g., segments the text into words, sub-words, punctuation, and so on). The engine 120 may additionally include a tagger which assigns word types to tokens (e.g., verb, noun, and so on). The engine 120 may additionally include a dependency parser which determines dependency information. Example dependencies are illustrated in FIG. 4B and described in more detail below. The engine 120 may additionally include a parser which parses the text based on the dependency information (e.g., the parser may describe relations between tokens). The engine 120 may additionally assign the base forms of words (e.g., determine lemmas of tokens), such as assigning ‘be’ instead of ‘was’ or ‘is.’ Example NLP engines may include spaCy, BERT, and so on as known by those skilled in the art.

The NLP engine 120 may be applicable to all natural languages and can work with any dependency tagging scheme as well as any part of speech (POS) tagging scheme. Examples of dependency tagging schemes include but are not limited to Stanford Dependencies, Google Universal Tags, ClearNLP Dependency Tags, and Universal Dependency. Examples of POS tagging schemes include but not limited to Penn Part of Speech Tags, and spaCy Fine-grained Tags. For simplicity purposes, English language, dependency scheme of Universal Dependency, and Spacy Fine-grained Tags are chosen to illustrate the system and method provided in this disclosure.

Thus, the NLP engine 120 may output a dependency tree 122. Nodes of the dependency tree 122 may represent tokens which have dependency information associated with them. For example, the dependency tree may be organized into parent and child nodes. As an example, a parent node may reflect an action (e.g., mixing) and child nodes may reflect materials which are to be mixed. From observations, it was found that certain dependency trees, such as trees corresponding to sentences of the document 102, may typically start with a verb, a noun, or an adjective as a root. Verb root typically indicates an action or a step, or a relationship between subjects and objects. Noun root can be a noun phrase used in titles, headings, or other numbered/bulleted lists, or a generalization of a subject in a sentence. An adjective is typically an attribute of a subject.

The information extraction engine 130 may analyze the dependency tree 122 to determine (e.g., extract) entities reflected in the tree 122. In some embodiments, the information extraction engine 130 may represent an NLP model which is trained to identify entities of interest. The engine 130 may additionally represent a rule-based engine which identifies entities. Example classifications used to extract entities are included in Tables 1-3 below. The engine 130 may thus identify whether a word included in the dependency tree 122 represents an entity. The engine 130 may additionally assign a classification (e.g., material, process, device, and so on).

TABLE 1

| Category | Entity Subcategory | Description | Examples |
|---|---|---|---|
| Material | Raw Material | A specific raw material, or its class/subclass | ginger, E. coli, bacteria |
| | Raw Material Part | Describe the part of the raw material | leaf, flower, root |
| | Chemical | A specific chemical element/ | dichloromethane, N,N- |
| | | compound/mixture/structure, or its class/subclass. | Dimethylformamide, fatty acids, |
| | | | receptor, surface receptor, |
| | | | polymer |
| | Process Output | Describe process output | mixture, solution, extract, |
| | | | distillate, isolate, concentrate, |
| | | | emulsion |
| | Product | Describe product | tincture, balm, oil, powder |
| Device | Device | A specific device used in a process, or its | reactor, condenser, container, |
| | | class/subclass | evaporator |
| | Device Component | Part of a device interacting with operators or other | inlet/output/port, switch, button, |
| | | devices | valve, control panel |
| Process | Process | Name of a manufacturing process | extraction, purification, |
| | | | dissolution, filtration |
| Device | Device Operation | Name of a device operation | connection, attachment, |
| Operation | | | configuration; |
| Operator | Operator | Name of roles operating on devices or running | operator, worker, engineer |
| | | processes | |
| Technology | Technology | Name of technology, or its class/subclass | chromatography, self- |
| | | | emulsification |
| Property | Quantifiable | Quantifiable properties with subcategories such as | 1.5 gr, 2.3 g, 500 mL, 100° C., |
| | Property | Mass, Volume, Concentration, Purity, Temperature, | 15%, 3 hrs, reduced pressure, |
| | | Pressure, pH, Percentage, Duration, etc. | room temperature |
| | Physical/Chemical | Describe a physical/chemical property of a material, | liquid, gas, solid; navy blue, |
| | Property | with subcategories such as State of Matter, Color, | water-soluble; saturated |
| | | Water-solubility, Saturation, etc. | |
| | Manner | Describe the manner of a step or action | slowly, dropwise manner |
| | Enumerated | State of a device, a device component, or a | on/off; high/medium/low |
| | Property | process, typically with a predefined list of values | |
| Numbered | Numbered Item | A reference for a numbered heading, section, or list | example 1, step 2, section 2.3, |
| Item | | item in the document, usually appear before the | previous step, first step |
| | | reference occurs | |

TABLE 2

| Unit Category | Unit Subcategory | Description | Example |
|---|---|---|---|
| Class | type, kind, class, group, category, species, | Classification with respect to | type, kind, class, group, |
| | strain, variety, etc. | certain property or concept | category, species, strain, |
| | | | variety |
| Procedure | Procedure Repetition | Repetition of a procedure | time, iteration, repeat, round |
| Repetition | | | |
| Quantifiable | Mass, Volume, Concentration, Purity, | Unit for a corresponding | km, mL, hour, hr., cm, ° C., % |
| Property Unit | Temperature, Pressure, pH, Percentage, | quantifiable property | |
| | Duration, etc. | | |

TABLE 3

| Verb | Verb | | |
|---|---|---|---|
| Category | Subcategory | Description | Examples |
| Procedure | Process Verb | A verb representing a step in which | freeze, cool, heat, stir, mix, wash, reflux, react, |
| Verb | | chemical or physical changes | crystalize, dissolve, dilute, distill, dry, filter, evaporate, |
| | | happen to the materials | pour, add, combine, extract, purify, concentrate, |
| | | | separate, grind, inject, spray, synthesize, |
| | | | biosynthesize, produce |
| | Device | An operation on devices to make | connect, disconnect, remove, attach, detach, put, |
| | Operation | connection between devices, set | open, close, turn, choose, click, switch, set, configure, |
| | Verb | parameters, transfer material from | move, transfer |
| | | one device to another, etc. | |
| Relationship | Sequence | A verb indicates the relative | precede, follow |
| Verb | Verb | sequence between subject and | |
| | | objects | |
| | Composition | A verb representing composition | Include, consist, compose, contain, have, belong |
| | Verb | relationship between the subject | |
| | | and objects. | |
| Outcome | Outcome Verb | A verb representing outcomes | provide, give, yield, afford, supply, get, obtain |
| Verb | | | |

The information extraction engine 130 thus identifies entities reflected in the dependency tree. Additionally, the information extraction engine 130 may adjust the tree 122 to form an information tree 132. For example, the information included in certain child nodes may be moved into parent nodes. In this example, child nodes which have information which contributes to the expression or property of the entity associated with a parent node may be combined into the parent node. This information is referred to herein as a local group, and local group connections are described below with respect to FIGS. 4A-4B. The information associated with a node may be referred to herein as an information list. This information list of entity may include entities recognized for a sub-tree of the node (e.g., child nodes of the node).

The knowledge map engine 140 may determine relationship information for the entities identified in the information tree 132. For example, example relationship information is included in Tables 4-5 below which are described in FIG. 5. In some embodiments, an NLP model may determine this relationship information. In some embodiments, a rule-based engine may determine the relationship information. An example relationship may include a parent node being a process verb and a child node being a noun indicating a material or device. With respect to the example of a material, the relationship may indicate that the material is an input to output of the process. With respect to the example of a device, the relationship may also indicate that the device is correlated to the process (e.g., used in the process).

Based on the relationship information, the knowledge map engine 140 may generate knowledge information. For example, the knowledge information may include an indication of knowledge map nodes which correspond to certain entities in the information tree 132. In some embodiments, the knowledge map nodes may correspond to entities which are one or more of processes, operation procedures, operations, devices, device components, and/or materials. These types of entities are illustrated in FIG. 2 with respect to the Legend portion (e.g., portion 240). As described above, each entity may have an information list which may reflect child entities. Based on the relationship information, this information list for a node may be linked to the corresponding text in the document 102. For example, in the left-portion 114 illustrated in FIG. 1A may reflect this relationship information between nodes. Additionally, the relationship information and information lists may be used to generate the right-portion 116 of FIG. 1A. For example, the material ‘compound 1’ in FIG. 1A may reflect a parent node with an information list that includes the chemical makeup and physical properties (e.g., mass). As will be described below with respect to FIG. 4A-4B, the information list may include information from child nodes which are connected via local group connections. Furthermore, and as illustrated in FIG. 2, a device configuration portion (e.g., portion 230) may be determined based on relationship information and information lists.

FIG. 2 is a graphical illustration of an example knowledge map 200 determined based on an input textual portion. Specifically, FIG. 2 illustrates an example of a manufacturing process knowledge model. In this example, each process step correlates to one or more input materials, one or more output materials, a set of devices in which the process step happens, and a set of operation procedure steps to prepare, run, and finish the process step.

There are three types of knowledge maps in this example: operation procedure map (e.g., portion 210), process map (e.g., portion 220), and device configuration map (e.g., portion 230). Operation procedure map describes the sequences of individual device operations and/or material process steps in natural language. Process knowledge map describes how materials change through process steps, including material nodes and process nodes. Each process node has properties, and each material used in the process node (e.g., an input or output) has a list of properties which are updated by corresponding process steps. For example, a property may reflect a temperature and the process node may cause a change in temperature of the material. Device configuration map describes how the devices are configured and operated to complete each process step. Each device or device component has properties, and each property has a list of property values which are updated by corresponding device operation steps. Initial preparation and maintenance of devices in the operation procedure may not be correlated to a specific process step if they are not involved in process steps.

Processes and device operations can be expressed or referenced in either verb form or noun form. For example, extract (presented as a verb in the text, not the noun representing the output of the extraction process) is a verb for the extraction process. For simplicity and unification, each process is denoted in verb form. The mappings between verbs and their corresponding nouns are maintained in a lookup table. In case a process step or a device operation is expressed as a noun, its corresponding verb will be obtained by searching lookup table and used as the name of the process step or device operation in knowledge map. Operations normally change the attributes of the operation target. For example, “Set the temperature of the reactor to 100° C.” changes the property “temperature” of the reactor to value “100° C.”. Some device operation verbs indicate the status changes. Mappings between the device operation verb/noun (may include adverbs) and status are maintained in a look-up table. In this way, device operation results are reflected in property values of the operation target. For example, “Close the valve” changes the value of the property “Operation Status” to “closed” for the device “valve”.

### Example Flowchart

FIG. 3 is a flowchart of an example process 300 to determine a knowledge map based on an obtained textual portion. For convenience, the process 300 will be described as being performed by a system of one or more computers (e.g., the knowledge extraction system 100).

At block 302, the system obtains a textual portion associated with a document. The system may obtain a portion of a document, such as a sentence, a paragraph, text under a sub-heading, or the entire document. As described herein, these portions may be individual processed and combined to form output for the document.

At block 304, the system obtains a dependency tree. In some embodiments, a natural language processing (NLP) model may be used to determine the dependency tree. Thus, the system may compute a forward pass through the NLP model based on the obtained textual portion. As described herein, the dependency tree may assign a type to a word (e.g., verb, noun) and optionally dependencies between words. For example, the dependencies may indicate whether a child node has a conjunctive relationship with a parent node indicating an order (e.g., the child node may describe an action or material which occurs prior to, or after, the parent node). As another example, the dependencies may indicate that a child node is an adverb modifier of a parent node. Example dependencies are illustrated in FIGS. 4B-4C and 6A-6B (e.g., ‘obj’ or object, ‘appos’ or apposition modifier, ‘obl’ or oblique argument or adjunct, and so on).

At block 306, the system extracts entities based on the dependency tree and forms an information tree. The system may identify, or otherwise recognize, entities based on the dependency tree. For example, the tree may include tokens (e.g., words) which are connected according to different dependency connections. These connections are described below with respect to FIG. 4B. The system may thus traverse the tree, optionally recursively, and identify entities based on the traversal. For example, the system may assign an entity classification (e.g., process, material, device, device configuration, and so on as described herein). Examples of entities are included in Tables 1-3.

At block 308, the system constructs (e.g., determines, generates) knowledge maps based on the information tree. The system uses relationship information, such as included in Tables 4-5 below, to relate the entities identified in the information tree. These relationships inform the particular information which is to be included in the knowledge maps. For example, the relationship information may indicate that a parent node represents a process to be applied to, or which uses, child nodes. In this example, the parent node may reflect a particular type of entity (e.g., a process verb) and the children may reflect particular types of entities (e.g., materials). The knowledge map may be determined via identifying knowledge map nodes which correspond to link group nodes. The knowledge map nodes may reflect particular types of entities as described herein (e.g., processes, materials, and so on). Additionally, the system may, in some embodiments, deduplicate the nodes to ensure that a single knowledge map node corresponds to multiple uses of an entity (e.g., the same compound may be referenced for use in different portions of input text). Deduplication may be based on the name, vector space representation of the associated word or token, and so on.

Thus, a knowledge map may include the above-described relationship to succinctly indicate the process and associated inputs/outputs. Advantageously, this information may have been spread around the input textual portion and the system may determine the relationship for ease of user understanding.’

At block 310, the system causes presentation of a user interface. The system may present the knowledge maps in a user interface to a user. Thus, the user may view easy-to-understand complex information in a digestible format rather than reading lengthy documentation. In this way, errors may be reduced as the user may rely upon the knowledge map rather than parsing complex documentation. As described in FIG. 2, there may be different types of knowledge maps which present different information. For example, operation procedure maps, process maps, device configuration maps, and so on.

In some embodiments, the knowledge maps may be provided to a system to automate manufacturing or chemical processing. For example, the system may take actions identified in the process map. The system may also configure devices used for the manufacturing or processing according to the device configuration map.

FIG. 4A is a flowchart of an example process 400 to generate an information tree based on a dependency tree. For convenience, the process 400 will be described as being performed by a system of one or more computers (e.g., the knowledge extraction system 100).

At block 402, the system accesses a dependency tree associated with a textual portion. As described above, the system generates a dependency tree based on dependencies assigned by a machine learning model or rule-based engine. Example dependencies are illustrated in FIG. 4B.

FIG. 4B illustrates dependency tags organized into different groups and used by the knowledge extraction system to generate the information tree. The disclosed technology divides dependency relations in NLP into three categories: link group, auxiliary group, and local group. The example tags are with respect to Stanford dependency tags (e.g., spaCy tags), although other tags may be used and fall within the scope of the disclosure herein.

These tags are known by those skilled in the art and not reproduced herein. However, as an example the ‘acl’ tag may represent an adjectival complement. The ‘advcl’ tag may represent an adverbial clause modifier. The ‘nmod’ tag may represent a modifier of nominal. The ‘nsubj’ tag may represent a nominal subject. The ‘obj’ tag may represent an object tag. The ‘obl’ tag may represent an oblique normal. The ‘neg’ tag may represent a negation modifier. The ‘advmob’ tag may represent an adverbial modifier. The ‘amod’ tag may represent an adjectical modifier. The ‘nummod’ tag may represent a numeric modifier.

Examples of the above-described tags are illustrated in FIG. 4C (e.g., amod, compound) and FIGS. 6A-6B (e.g., obl, case, det, appos, punct, conj, nsubj: pass, and so on). Thus, the dependency information may include assignment of these tags (e.g., assignment between word connections).

The tags in the link group typically represent a knowledge map relationship between the two entities represented by the parent token and the child token. The entities defined in the disclosed technology include but are not limited to entities in normal definition (real-world object), process/operation entities represented by corresponding verbs, properties, property values, and other things of interest to the defined Knowledge models.

The tags in the auxiliary group are usually used to facilitate the recognition of the relationship between the parent token and the child token as well as the determination of references.

The tags in the local group normally contribute to the expression or property of the object represented by parent token. The tags in the local group usually connect child tokens which in turn connect their child tokens only with tags in the local group. Therefore, by recursively traversing through the dependency tags in the local group, a continuous span of a text will be formed, which is used in the disclosed technology to extract the entities and other information with exceptions such as nested entities.

At block 404, the system traverses the dependency tree based on link group connections. The system may initiate at a root node of the tree and traverse to child nodes which have link group connections. In some embodiments, the processing may be effectuated recursively. The system may additionally analyze the dependency tree to identity entities, for example as described above with respect to FIG. 1B.

Specifically, entities may be recognized using an NLP mode, a rule-based approach, a look-up table (e.g., optionally specific to a knowledge domain), and so on. The system determines whether text in a node is recognized. If it is determined that the text is recognized, the recognized entity is added together with its category or subcategory to the information list of the current node. The system then determines whether the current node has at least one child with a local group connection. If it is determined that the current node has at least one child with a local group connection, the system continues with another determination regarding if nested entity situation happens in the span formed by the current token and its children. If it is determined that nested entity situation happens, the system recognizes the nested entities. If it is determined that nested entity situation does not happen, the system gets the next nearest child node with a local group connection (e.g., to recursively extract information). The information list of the returned child node is obtained and appended to the information list of the current node.

At block 406, the system forms information lists for link group nodes based on local group connections. The local group connections may represent contributions to an expression or property of an entity associated with a parent. For example, a child node indicating a value may be connected via a local group connection for a parent indicating a measurement type (e.g., millimolar). The system may collapse, trim, or otherwise remove the child node. Specifically, the system may update an information list for the parent node to include the information in the child node. Additionally, a parent node connected via link group connections to child nodes may have their information lists updated to include the entities in their span (e.g., the parent node's information list may include the entities identified in the child nodes).

At block 408, the system generates an information tree based on the information lists 408. As described in block 406, the system may adjust the tree to remove child nodes which have local group connections to parent nodes. Additionally, the system may associate information lists to each link group node having at least one local group connection to a child node. The child node may be removed such that the tree is truncated.

FIG. 4C illustrates an example of adjusting a portion of a dependency tree 420 as part of a process to generate an information tree. In the illustrated example, the portion of the dependency tree 420 includes a root node (e.g., ‘solution’) and child nodes (e.g., ‘ml’, ‘saturated,’ and ‘chloride’) with ‘ml’ having child node ‘10’ and ‘chloride’ having child node ‘sodium’.

In the example, the connections between the parent nodes and child nodes are local group connections. The system may initiate processing at the root node in some embodiments. Additionally, the system may recursively analyze the tree 420 in some embodiments such that it may traverse first to ‘chloride’ and then to ‘sodium.’ As described herein, the system may identify the entity ‘sodium’ based on a chemical manufacturing or processing knowledge domain. The information from this child node may be moved upward to its parent node (e.g., ‘chloride’). Thus, the information may reflect ‘sodium chloride’). The system may determine whether ‘sodium chloride’ should be moved upward to the parent ‘solution.’ To effectuate this determination, the system may determine whether ‘sodium chloride solution’ is a recognized entity. In this example, the system will determine that ‘sodium chloride’ is an entity but not ‘sodium chloride solution.’ Thus, the system will update the information for the root ‘solution.’

For example, the information list for the root (e.g., ‘solution’) may therefore include ‘solution’ and ‘sodium chloride.’ Similarly, the system may traverse to node, ‘saturated’. Since this does not have a child node, the system may determine whether ‘saturated’ should be moved upward to ‘solution.’ Similar to the above, the system will instead append ‘saturated’ to the information list for ‘solution.’ The system may then traverse to ‘ml’ and ‘10’. Since ‘10 ml’ may reflect an entity (e.g., as noted in Tables 1-3 with respect to, for example, quantifiable property), the system will combine these nodes. The system will then append ‘10 ml’ to the information list for solution (e.g., 10 ml solution will not be recognized as an entity).

Thus, the information list for node ‘solution’ may include the following entities (e.g., along with example classifications of the entities):
“10 mL” (Property|Quantifiable Property|Volume)
“saturated” (Property|Physical/Chemical Property)
“sodium chloride” (Material|Chemical)
“solution” (Material|Process Output)

FIG. 5 is a flowchart of an example process 500 for generating one or more knowledge maps based on an information tree and relationship information associated with nodes of the information tree. For convenience, the process 500 will be described as being performed by a system of one or more computers (e.g., the knowledge extraction system 100).

At block 502, the system accesses an information tree. As described in FIGS. 4A-4C, the information tree may include nodes with recognized entities along with information lists for the entities.

At block 504, the system determines relationship information between parent link group nodes and child link group nodes. The system identifies parent link group nodes which, in some embodiments, may be of certain types. For example, these nodes may reflect entities which are one or more of processes, operation procedures, operations, devices, device components, materials, and so on.

The system determines relationship information between nodes. For example, Tables 4-5 describe example relationships:

TABLE 4

| | Parent's | | | |
|---|---|---|---|---|
| | Auxiliary | | | |
| Parent | Tags | Child | Child's Auxiliary Tags | Relationship |
| process verb | | material/device [Noun] | | material/material in device as input |
| [Verb] | | <obj> | | or output of process, determined by |
| | “be” [Verb] | material/device [Noun] | | process verb |
| | <aux> | <nsubj:pass> | | |
| | | material/device [Noun] | | |
| | | <obj> | | |
| | | material/device [Noun] | “to”/“into”/“onto”/“with”/“from”/etc. | |
| | | <obl> | [IN] <case> | |
| | | property value [Noun] | “for”/“at”/etc. [IN] <case> | property value as property value of |
| | | <obl> | | process |
| | | operator [Noun] <nsubj> | | operator as owner of process |
| | | operator [Noun] <obl> | “by” [IN] <case> | |
| | | technology [Noun] <obl> | “by” [IN] <case> | technology as a property of process |
| | | outcome verb [VB] | “to” [TO] <case> | material from outcome verb as |
| | | <advcl> | | output of process |
| | | outcome verb [VBG] | | |
| | | <xcomp> | | |
| process verb | “be” [Verb] | process verb [VBN] | | child process follows parent process |
| [VBN] | <aux> | <conj> | “and” [CC] <cc> | |
| outcome verb | | material [Noun] <obj> | | material as output; |
| [VB/VBG] | | | | property value as property value of |
| | | property value [Noun] | “as” [TO] <case> | material |
| | | <obl> | | |
| process | | material [Noun] <nmod> | “with”/”on”/”of”/etc. [IN] <case> | material as input or output of |
| [Noun] | | | | process, determined by the process |
| process | | material [Noun] <nmod> | “of”/”in”/”with”/etc. [IN] <case> | process output as output of process |
| output [Noun] | | | | with material as input |
| material | | property value [Noun] | “(“/”)”[LRB/RRB] <punct> | property value as property value of |
| [Noun] | | <appos> | | material |
| | | material [Noun] <appos> | “(“/”)” [LRB/RRB] <punct> | child material as alias of the parent |
| | | | | material |
| | | process verb [VBN] | | material as output of process |
| | | <acl/acl:relcl> | | |
| property value | “,”[,] <punct> | property value [Noun] | | child property value appends the |
| [Noun] | | <appos> | | parent property value |
| <appos> | | | | |
| property value | | material [Noun] <nmod> | “of” [IN] <case> | Material has property with property |
| [Noun] | | | | value |
| Property value | “be” | material/process/device | | property value as property value for |
| [JJ] | [Verb]<cop> | [Noun] <nsubj> | | material/process/ device |
| composition | | material, process. | | whole vs parts, determined by the |
| verb [VB] | | device [Noun] <nsubj>; | | verb, its POS and dependency |
| | | material, process, or | | |
| | | device [Noun] <obj> | | |
| sequence verb | | process/operation | “by” [IN] <case> | child process/operation is before or |
| [VBN] | | [Noun] <obl> | | after grandparent process/operation, |
| | | | | determined by the sequence verb |

TABLE 5

| | Parent's | | | |
|---|---|---|---|---|
| | Auxiliary | | Child's Auxiliary | |
| Parent | Tags | Child | Tags | Relationship |
| composition verb | | material, process, device | | whole vs parts, determined by the |
| [VB] | | [Noun] <nsubj>; | | verb, its POS and dependency |
| | | material, process, or device | | |
| | | [Noun] <obj> | | |
| sequence verb [VBN] | | process/operation [Noun] | “by” [IN] <case> | child process/operation is before or |
| | | <obl> | | after grandparent process/operation, |
| | | | | determined by the sequence verb |
| operation verb [Verb] | | operator [Noun] <nsubj> | | operator as owner of operation |
| connection verb | “be” [Verb] | device/device component | | device/device component is connected |
| [Verb] | <aux> | [Noun] <nsubj:pass> | | to another device/device component |
| | | device/device component | | |
| | | [Noun] <obj> | | |
| | | device/device component | “to”/etc. [IN] <case> | |
| | | [Noun] <obl> | | |
| configuration verb | “be” [Verb] | property [Noun <nsubj:pass> | | property is set to property value |
| [Verb] | <aux> | | | |
| | | property [Noun] <obj> | | |
| | | property value [Noun] <obl> | “to”/etc. [IN] <case> | |
| device component | | device [Noun] <nmod> | “of”/”on”/”in”/etc. | device component is part of device |
| [Noun] | | | [IN] <case> | |
| entity [Noun/JJ] | | entity with similar category as | | child appends the inclusive/alternative |
| | | parent [Noun/JJ] <conj> | | entity list starting with parent, |
| | | | | depending on “and” or “or” |
| | | | “and” [CC} <cc> | child appends the inclusive entity list |
| | | | | starting with parent |
| | | | “or” [CC} <cc> | child appends the alternative entity list |
| | | | | starting with parent |
| process verb [VBN] | | numbered item | “in” [IN] <nmod/obl> | parent is a reference to the |
| outcome verb [VBN] | | | | corresponding object in child region |
| process [Noun] | | | | |

At block 506, the system generates individual knowledge maps based on the relationship information and information tree. For example, the relationship information indicates relationships between parent nodes and all link group child nodes.

The system may determine information reflecting an order or ordering associated with the input textual portion. For example, a conjunct token list may be created which indicates conjunct dependency and relationship introduced by a sequence verb. A non-conjunct token list may be created to include all the non-conjunct link group child nodes. In this example, the conjunct token list may include actions (e.g., processes) which occur after, or prior to, an action (e.g., process) of a parent node. An example of this list may be understood with reference to FIG. 6B. For example, a root (e.g., 602) may indicate that two materials are added and a child node (e.g., 614) may indicate that the result of the adding is refluxed.

Thus, in FIG. 6B the conjunct token list may include ‘add’ and ‘reflux’. Each conjunct token list may have an associated non-conjunct token list. In the example, the non-conjunct token list for reflux may include the children (e.g., children connected via link group dependencies).

The system may obtain a node identified in the non-conjunct token list. These nodes may be processed, for example to determine relationship information. Additionally, and as described herein, information lists of parent nodes may be updated to include information from child nodes. The system may then identify a next conjunct node and process the child nodes from the associated non-conjunct token list. The system may continue until the conjunct nodes are processed.

While the description above focused on a conjunct token list including processes (e.g., actions, such as add or reflux). As may be appreciated the conjunct token list may include other types of words. For example, materials may be identified in a conjunct token list. As an example, there may be a process to add chemical 1 to a substance. For this example, a textual portion may indicate that chemical 2 is then added. Similarly, the textual portion may indicate that chemical 3 is then added. Thus, there is an ordering of the addition of these chemicals. In this example, the conjunct token list may thus include the chemicals in the above-described order such that the system understands their order.

In some embodiments, the system may determine that the obtained textual portion has both process and operation type knowledge nodes. The system may then correlate each process node to the procedure nodes operating on the devices. For example, the system may search the device in which the process material is in for its currently connected devices. The operation procedure steps on the currently connected devices between the last operation procedure step of the previous process node and the current process node are assigned to the current process node. The operation procedure steps on the currently connected devices between the current process node and the next process node are assigned to the current process node.

Thus, the system may generate knowledge maps based on the particular link group nodes. For example, the system may determine relationships between processes, materials, and properties thereof. For processes, the system may generate a knowledge map similar to that illustrated in portion 220 of FIG. 2. For example, the system may determine that a process is related to particular materials. In this example, the information lists may inform properties of the materials (e.g., these properties may have been local group connections to the materials). The system may also generate a knowledge map similar to that illustrated in portion 210 of FIG. 2. For this example, the system may tag, or otherwise characterize, words of the textual portion based on the relationship, and information lists, described herein.

FIG. 6A illustrates an example dependency tree 600. This tree may have been generated by an NLP model based on input of, “To this solution was added iodine (0.8 gr, 3.15 mmol), and then the reaction mixture was refluxed for 3 hrs.”

Thus, the tree 600 has a root node 602 of ‘added.’ The NLP model has determined that this represents the root of the sentence since, as an example, it reflects the initial action to be performed. A child node 604 (e.g., ‘iodine’) is connected via a link group dependency to child node 606 (e.g., ‘grams’) which is connected via a local group dependency to child node 608 (e.g., ‘0.8’) and a link group dependency to child node 610 (e.g., ‘mmol’). Child node 610 is connected via a local group dependency to child node 612 (e.g., ‘3.15).

FIG. 6B illustrates an example information tree 620 determined based on the example dependency tree 600. The information tree 620 illustrates example entity classifications. For example, root node 602 has been recognized as an entity which is a process. Its child node 604 has been recognized as an entity which is a material. Child node 606 has been recognized as an entity which is a property. Child node 610 has been recognized as an entity which is a property. In some embodiments, the processing may be performed recursively.

As illustrated, child node 608 has been removed from the tree 620. For example, and as described above with respect to FIGS. 4A-4C, the local group connection may cause the system to append the information from node 608 onto the information list for node 606. Thus, node 606 now reflects a combination (e.g., ‘0.8 grams’).

FIG. 6C illustrates example knowledge map(s) determined based on the example information tree. The operation procedures knowledge map includes the sentence identified above in the middle and bottom with respect to procedures 2.1 and 3.1. Additionally, the map includes a prior sentence, “Compound 1 (1 gram) was dissolved in 15 ml of toluene.” As described above, in some embodiments the system may analyze a portion of text at a time (e.g., one sentence at a time, one paragraph, and so on). Thus, this first process may be included as operation procedure 1.1.

In the illustrated example, operation procedure 1.1 includes reference to two materials (e.g., toluene and compound 1), with the two materials being inputs. Operation procedure 2.1 includes reference to two materials (e.g., solution and iodine), with the two materials being inputs. Operation procedure 3.1 includes reference to one material (e.g., reaction mixture). The system may, in some embodiments, assume that a process has at least one input. The system may, in some embodiments, assume that a process has at least one output. Thus, for operation procedure 1.1 the system may analyze the sentence and create an output associated with the dissolving process. For example, the system may create a temporary name (e.g., dissolve output). The system may then analyze the subsequent sentence. For this sentence and procedure 2.1, the system may note the two inputs of solution and iodine. The system may therefore determine that the temporary name (e.g., dissolve output) is to be updated to correspond to ‘solution’. For example, the system may note the usage of ‘this’, or similar words (e.g., ‘the’) prior to solution and determine that solution is meant to refer to a prior operation procedure. In FIG. 6C, the system may therefore associate the output of dissolve as being the solution reference in the text of operation procedure 2.1.

In some embodiments, a single process or operation may be preferred for an operation procedure (e.g., a single verb or action). Since the sentence identified above includes two processes (e.g., add, reflux), the system has created two operation procedures. Additionally, the auxiliary group connections may be used for the splitting. For example, FIG. 6B illustrates that a comma and the word ‘and’ are connected to root 602. As another example, reflux 614 is characterized as having a conjunct (e.g., ‘conj’) dependency indicating that it may come after. Thus, the system has included the first process (e.g., add) and the second process (e.g., reflux) on different operation procedure lines.

As illustrated, root node 602 is characterized as a ‘process’ while node 604 is recognized as a material. Nodes 606 and 610 have been recognized as properties. The process knowledge map graphically illustrates this. For example, node 604 is illustrated as being input into process node 602. The properties 606, 610 of node 604 are presented proximate to node 604. These properties may have been included in the information list associated with ‘iodine.’ Additionally, the next process (e.g., reflux) is illustrated below process 602.

With respect to nodes 602 and 604, these nodes may be related according to the relationship information of Tables 4-5. For example, this table includes a parent being a ‘process verb’ with a child being a material associated with tag ‘obj.’ In this example, the system may use the relationship information to determine that node 604 is an input to node 602. The system may also use the relationship to determine that they should be connected via a particular type of connection shown in the Legend (e.g., material flow).

Additionally, a prior sentence may reference a particular node (e.g., node 603). This node indicates use of ‘compound 1’. A prior sentence or sentences may include text to generate compound 1 or which otherwise references compound 1 (e.g., a temperature for compound 1, whether it is to be filtered, and so on). When generating the knowledge map, the system may generate a knowledge map node corresponding to compound 1 when analyzing the prior sentence or prior sentences. Thus, when analyzing the text for operation procedure 1.1, the system may determine that compound 1 corresponds to the previously created knowledge map node. In this way, the system may update the process knowledge map to include nodes above compound 1 (e.g., steps to generate the compound). These nodes may include words from sentences anywhere previously in a textual portion. For example, the textual portion may include initial steps to create compound 1. In this example, the textual portion may then include a significant amount of other text until reaching the text included in procedure 1.1. Since the system has already created a compound 1 knowledge map node, the system may associate the action in procedure 1.1 with the node (e.g., dissolving compound 1 with toluene).

FIG. 6D illustrates example knowledge map(s) which include operation procedure, process, and device configuration nodes. This figure illustrates a more device configurations. As described above with respect to Tables 1-3, nodes may be recognized as entities with a device classification. Thus, information related to devices may be presented as a knowledge map. For example, water source is recognized as a device classification while faucet is recognized as a component device classification. Additionally, the system has linked (e.g., correlated) the device configuration to specific operation procedures (e.g., faucet opens as described in 3.4 and closes as described in 3.9).

In one embodiment, components of constructed knowledge maps are grouped into subsystem knowledge maps to create hierarchy knowledge maps with respect to certain rules. The hierarchy can be multiple levels. For process knowledge maps, the top level can be a single process to convert input materials into output materials.

With respect to grouping, in some embodiments the system described herein may generate a grouping which is associated with a knowledge map. For example, a knowledge map which describes a process by which a particular compound is created may be grouped. In this example, a name may be associated with the grouping such that it may be accessed by a user. When analyzing text which uses the particular compound, the generated knowledge map may include a node related to use of the particular compound. In some embodiments, the user may provide user input to the node via an interactive user interface which is presenting the knowledge map. The interactive user interface may then present the knowledge map associated with creation of the particular compound. For example, the system may determine (e.g., based on the name, metadata, and so on) that the node is associated with its own knowledge map.

In some embodiments, a user may cause grouping of a portion of a knowledge map. For example, the user may name or otherwise title the grouping. A user interface presenting the knowledge map may then be updated to cause the portion to reduce in size and optionally be represented as a node or graphical indicia associated with an underlying knowledge map. In this way, the user may collapse portions of the knowledge map into manageable sizes. Similar to the above, the user may provide input to cause a grouping to expand into a full knowledge map.

In one embodiment, input/output materials are composed of subsystems or components, and the composition knowledge maps are extracted and constructed from the input document according to specific knowledge models. For example, drugs are wrapped in water-soluble polymers for delivery purpose.

In one embodiment, the constructed knowledge maps are compared to the identified models from scanned pictures of the block diagrams in the documents to validate the consistency between the text descriptions and corresponding block diagrams.

### Manual Generation—Example User Interface Flow

As described herein, structured or unstructured text may be analyzed to extract, and organize, included information. An example of text described above is a manufacturing process, such as a chemical manufacturing process to output a material. The knowledge extraction system 100 may use artificial intelligence techniques, such as machine learning and natural language processing techniques, to logically organize the text into disparate processes. For example, and as illustrated in FIG. 2, text describing a manufacturing process may be organized into discrete operation procedures.

As may be appreciated, such organization of text into discrete procedures may be used to embody, or otherwise record, a manufacturing process. For example, and with respect to a chemical manufacturing process, a worker or automated system may perform the procedure (e.g., as illustrated in FIG. 2) to manufacture a particular material. Thus, the knowledge map(s) generated by the knowledge extraction system 100 may convert complex manufacturing text into discrete steps able to be followed.

An entity may record such discrete steps in a manual or document to be read by workers or to be ingested by an automated system. Using the artificial intelligence techniques described herein, the manual may be ensured to reliably reflect potentially complex processes described in the original text. For example, the manual may include specific steps to perform along with configuration steps to perform on devices utilized in the manufacturing process. An example of such steps is included in FIG. 6D.

However, over time a manufacturing process may be refined or otherwise adjusted. For example, a new version of the original text may be generated which adds and/or removes portions of the original text. In this example, the changes may cause specific steps to be performed differently, include different inputs and outputs, have different device configurations, and so on. At present there is no way to automate the updating or adjustment of a manual associated with implementing the text. For example, an entity may prefer to revise a manual used by workers or automated systems rather than generate a new manual from the ground up. Indeed, there such manufacturing processes may be continuously undergoing revisions such that ground up processing may be compute intensive. Additionally, workers trained based on an existing manual may require additional time to understand a newly generated manual. Thus, it would be advantageous for the knowledge extraction system 100 to update an existing manual based on detected changes to a manufacturing process text.

In addition to manufacturing processes, and as described herein, the knowledge extraction system 100 may analyze text such as governmental regulations, industrial standards, best practice, requirement documents, design documents, operation procedures, patents and so on. The description below includes techniques to substantially automate the refinement of a manual, with the example of a governmental regulation used for convenience (e.g., a code of federal regulations (CFR)).

The CFR codifies federal regulations for a plethora of different subject matter. For example, 49 CFR includes regulations related to the domestic transportation of hazardous materials. This CFR is updated at a regular cadence and includes a multitude of chapters each with a substantial number of parts/sections. As an example used below, 49 CFR 192 includes regulations for transportation of natural and other gas by pipeline.

An entity involved in transporting gas by pipeline is required to conform to the regulations, which are complexly written, commonly changed, and routinely reference disparate portions of the CFR. Similar to a manufacturing process, the entity may have a manual written in easier-to-understand prose for consumption by workers our automated systems. In this way, a worker may review the manual in the normal course of their work and ensure that their actions are in compliance with the CFR.

Due to the routine adjustment of the CFR, such manuals are in need of continual revision. The CFR adjustments may introduce substantial complexity with respect to revising the manual. For example, substantial expertise may be required to ensure that CFR adjustments are properly reflected in revised manuals. Additionally, revisions which are overly complex, or result in an overly distinct manual, may be difficult for workers or automated systems to follow.

As will be described, the knowledge extraction system 100 may automate the above-described process. For example, the system 100 may identify distinctions between versions of text (e.g., versions of a CFR). In this example, the distinctions may represent deletions and/or additions of text. The system 100 may determine knowledge map(s) for portions of text which are adjusted in the newer version of the text. For example, a portion of text may newly indicate the exclusion of a set of CFR sections in particular circumstances. In this example, the system 100 may generate a knowledge map which identifies the exclusions as linked to the particular circumstances. The knowledge map may be analyzed to determine effects on other knowledge maps. For example, other knowledge maps may be modified to exclude the set of CFR sections where appropriate (e.g., based on the particular circumstances).

Based on the knowledge maps, the knowledge extraction system 100 may determine changes to be made to a manual. For example, and with respect to the example of exclusions, the system 100 may determine that particular sections of the manual are to be modified (e.g., to remove reference to the set of CFR sections). In this example, the system 100 may identify portions of the manual implicated by the CFR changes. As an example, the system may compare knowledge maps generated from the manual and the CFR. In this way, the system 100 may identify corresponding manual and CFR portions based on similarities between associated knowledge maps. The knowledge extraction system 100 may thus effectuate changes to the manual based on the changed CFR.

Advantageously, and as will be described, a succinct user flow may be followed by one or more users to ensure the manual is maintained up to date. For example, a user may quickly review changes to the CFR which are flagged by the system 100. The user may then confirm, reject, or adjust, the changes which are to be implemented with respect to knowledge maps generated based on the CFR. Similarly, the user may review, and optionally adjust, potential changes to the manual.

In this way, and in some embodiments, the user may leverage the system 100 to perform automated actions and suggestions to the manual. The user may maintain a human in the loop presence to confirm accuracy with respect to manual. Thus, the system 100 may provide substantial technical savings through the automated techniques and succinct user experience flow described herein. In some embodiments, the system 100 may automatically update the manual absent a user.

The above and other features will now be described in more detail.

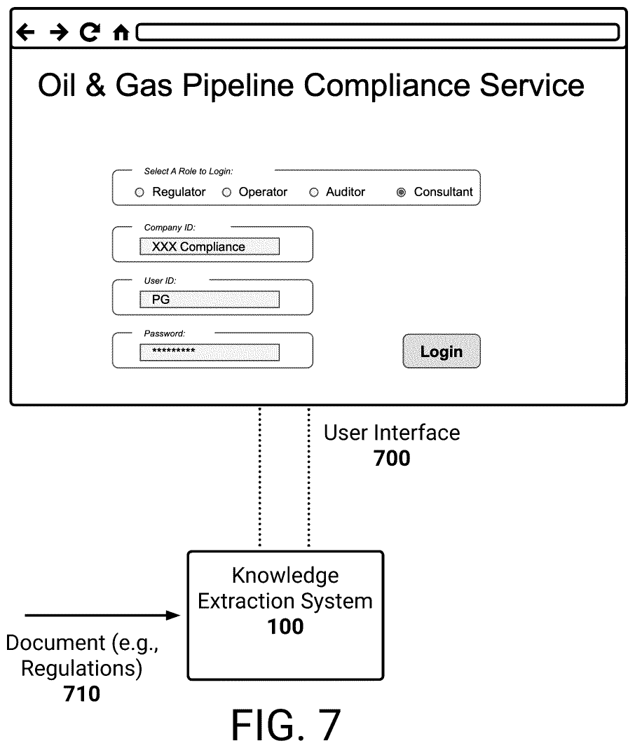

FIG. 7 illustrates the knowledge extraction system 100 presenting a user interface 700 associated with updating a manual. The knowledge extraction system 100 may receive a document 710 (e.g., a manufacturing process, a regulatory document, such as a code of federal regulations section, and so on) and, as will be described, compare the document 710 to a prior version of the document. For example, the system 100 may compare a newly released version of a regulatory code with a prior version of the regulatory code. As will be described, the system 100 may then automate, or substantially automate, the updating of a manual based on the comparison. In this way, the system 100 may substantially reduce a time, and reduce errors associated with, updating manuals for worker or automated system consumption.

As described above, the system 100 may analyze text included in the document 710 and generate knowledge maps. With respect to a manufacturing process, and as one example, individual knowledge maps may correspond to individual process steps included in the manufacturing process. With respect to a regulatory code, individual knowledge maps may correspond to individual portions of the regulatory code (e.g., individual sentences, individual groupings of text, and so on). Thus, the knowledge extraction system 100 may have access to knowledge maps generated based on the received document 710.

For a regulatory code, the system 100 may identify entities and associated properties. As described above, with respect to at least FIGS. 1A-1B, the system 100 may extract entities and assign a classification to the entities. With respect to a manufacturing process, example classifications may include materials, processes, devices, and so on. With respect to a regulatory code, Table 6 below includes examples of entities. As may be appreciated, the examples of entities are for illustrative purposes and the system may leverage machine learning techniques to identify arbitrary types of entities.

TABLE 6

| Entity Category | Label | Description | Example for Oil and Gas Pipelines |
|---|---|---|---|
| Component | CMP | Components or subsystems of systems | components including pipes, valves, various |
| | | | stations, and fabricated assemblies |
| Condition | CND | Conditions to determine the following tasks or | “If the pipeline contains plastic pipe or |
| | | specifications | components, E |
| Contact | CTI | Contact Information | Email, URL, phone number, address |
| Information | | | |
| Event | EVT | Events | failure, incident, accident, rupture, leakage |
| Material | MTR | Materials | plastic, metal, polyamide |
| Method | MET | Algorithm to determine values or value ranges of | “Integrity assessment method”, “methods |
| | | properties of objects based on inputs | being used to establish MAOP” |
| Organization | ORG | Organizations | ISO, PHSMA, ASTM, GTI |
| Person | PER | representative, manager, operator, etc. | administrator, inspector, manager, operator |
| Procedure | PRC | Detailed step-by-step instructions to carry out a task | welding Procedure, inspection procedure |
| | | or process | |
| Reference | REF | Unique reference to the whole or certain section of a | 49 CFR 192.9(b), § 192.615, paragraph |
| | | document | (e)(2)(ii), API RP 1162, ISO 9712 |
| Requirement | REQ | Requirement in natural language in the content of | “All pumps for firewater systems shall be |
| | | regulations or standards | inspected and operated weekly.” |
| Requirement | RQF | Reference to the requirements in certain sections of | “Requirements of §§ 192.617(b) through (d) |
| Reference | | regulation documents | and 192.635.” |
| Specification | SPC | Specifications to define the value or value range for | “design pressure for plastic pipe may not |
| | | a property of an object | exceed a gauge pressure of 100 psig”, “a DF |
| | | | of 0.40 may be used in the design formula” |
| System | SYS | Systems for the operators to work on, including | “Pipeline system” |
| | | software and hardware | |
| Task | TSK | A piece of work or activity to be completed. A task | “public education program”, “operator must |
| | | can contain a series of subtasks. A program, a | determine the stress level”, “investigate |
| | | process, or a plan can be generalized as a complex | failure and incident”, “design evaluation” |
| | | task. A task is centered on an action represented by | |
| | | a verb, a verb phrase, or a noun phase. | |
| Technology | TEC | Technology for specific tasks | rupture-mitigation valve (RMV), direct current |
| | | | voltage gradient (DCVG) |
| Property | PPT | property of an object, can be physical/chemical | type, outer diameter, length, material type |
| | | properties, or artificially defined properties, or | |
| | | another object | |

Similar to the above, the entities may have different properties which are identified by the system 100. For example, the system 100 may execute engine 130 (e.g., in FIG. 1B) to extract entities and form an information tree which identifies the properties. Example properties for a System entity are included below in Table 7 for illustrative purposes.

TABLE 7

| Property Name | Property Type | Data Type | Description | Value Range | Unit |
|---|---|---|---|---|---|
| opid | Identifier | int | OPID | [min, max] | |
| commodity | MTR/product | enum | Commodity | [“crude oil”, “natural gas”, | |
| | | | | “refined petroleum”, . . .] | |
| onshore_type | PPT/enum | enum | Onshore or offshore | [“onshore”, “offshore”] | |
| function_type | PPT/enum | enum | Types defined for pipelines with | [“transmission”, | |
| | | | respect to functionality | “gathering”, “distribution”] | |
| onshore_gathering_type | PPT/enum | enum | Types defined for onshore | [“Type A”, “Type B”, | |
| | | | gathering pipelines | “Type C”, “Type R”] | |
| distribution_type | PPT/enum | enum | Types defined for distribution | [“main”, “service”, . . .] | |
| | | | pipelines | | |
| outside_diameter | PPT/quantifiable/length | float | Outside diameter of pipes used | [min, max] | in |
| | | | to construct the pipeline | | |
| wall_thickness | PPT/quantifiable/length | float | Wall thickness of pipes used to | [min, max] | in |
| | | | construct the pipeline | | |
| maop | PPT/quantifiable/pressure | float | Maximum allowable operating | [min, max] | psig |
| | | | pressure (MAOP) | | |
| length | PPT/quantifiable/length | float | Length of pipeline | [min, max] | |
| pipe_material_type | MTR/chemical | enum | Material type of pipes used to | [“metal”, “plastic”, | |
| | | | construct the pipeline | “composite”, . . .] | |
| component | CMP | object | Components of the pipeline, | | |
| | | | including pipeline segments, | | |
| | | | pipes, valves, etc. | | |
| . . . | . . . | . . . | . . . | . . . | . . . |

The knowledge extraction system 100 may thus leverage machine learning techniques, such as natural language processing, which recognize such identities. As included in Tables 6-7, the examples are specific to regulatory codes for oil and gas pipelines. One skilled in the art will understand that additional examples may be used and fall within the scope of the current disclosure.

In the illustrated figure, the knowledge extraction system 100 has received document 710 which may represent a new version of the document. The system 100 may, in some embodiments, monitor network locations for new versions of the document 710. For example, and with respect to a regulatory code, the system 100 may monitor for updates provided to an official government website. The system 100 may optionally alert a user, such as a user of user interface 700.

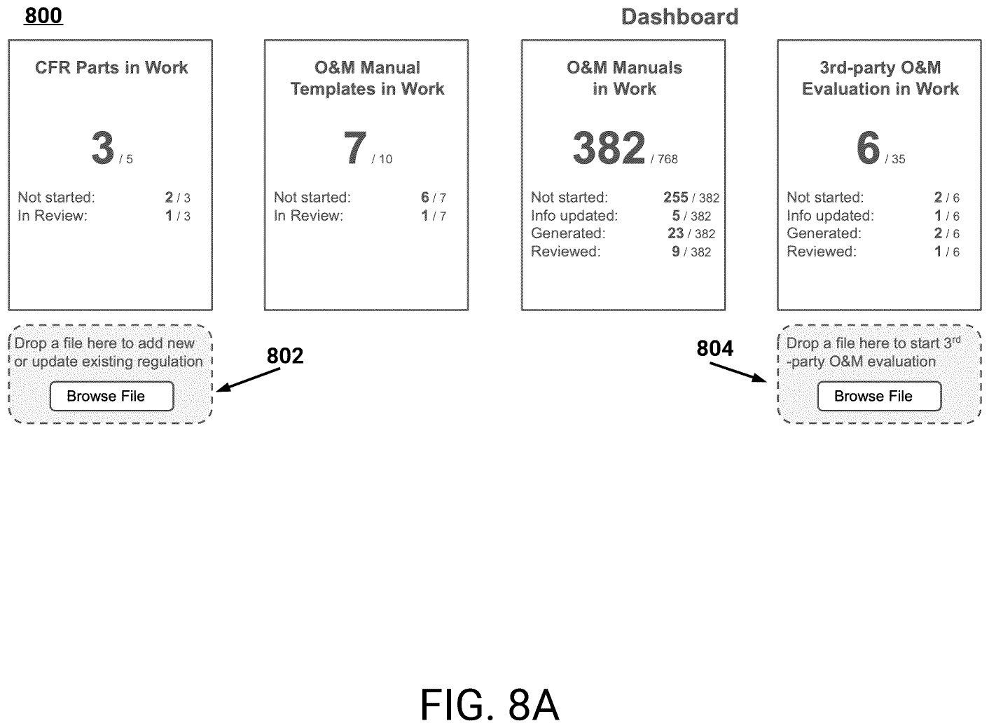

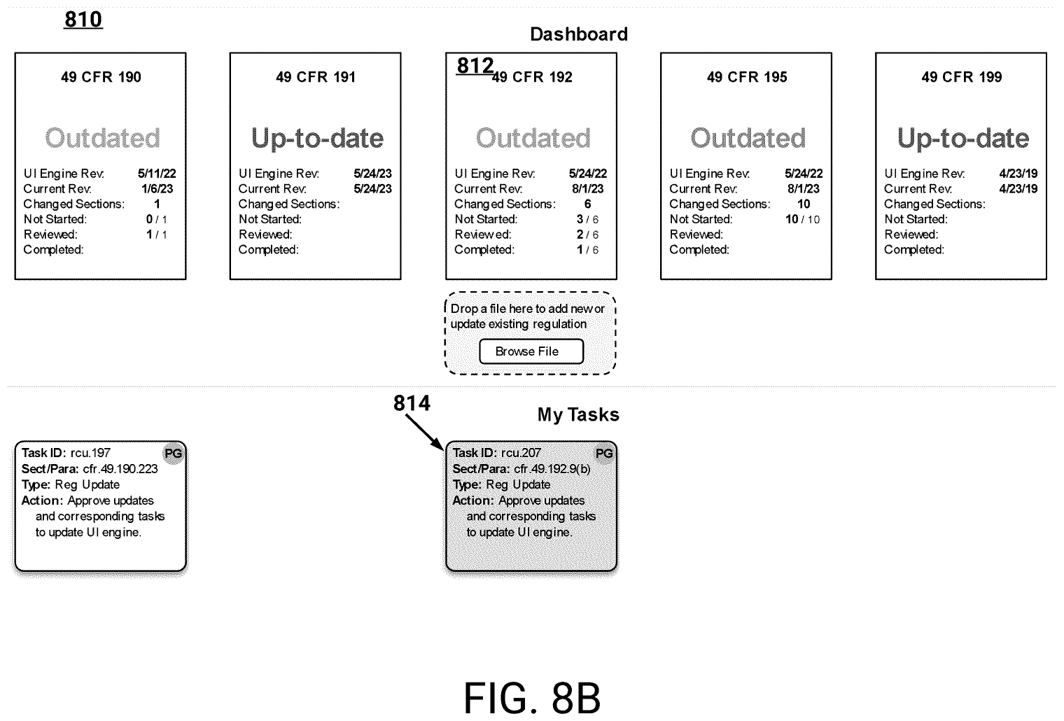

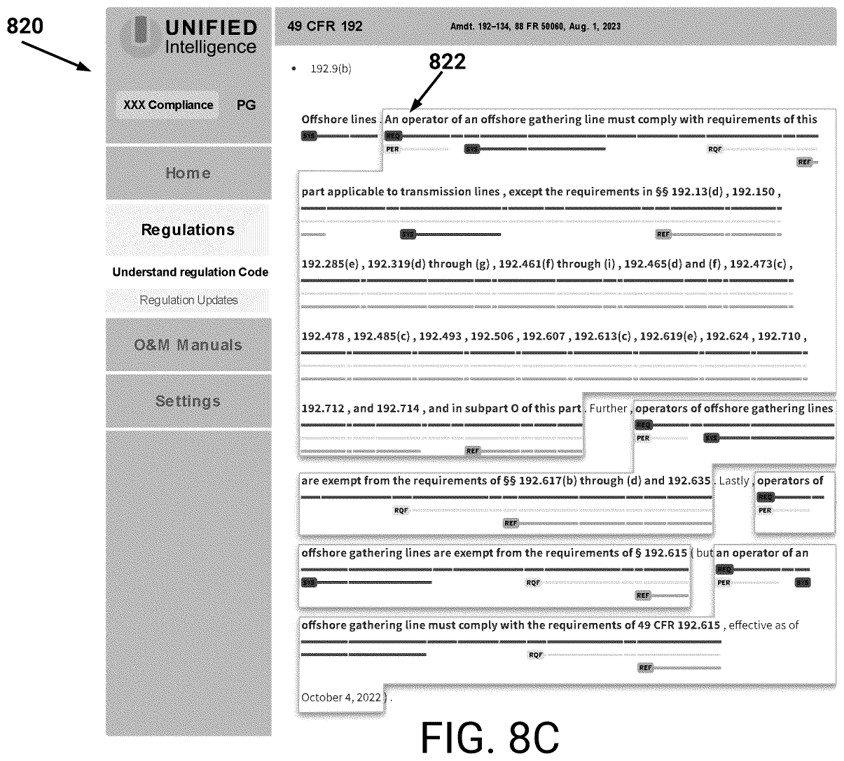

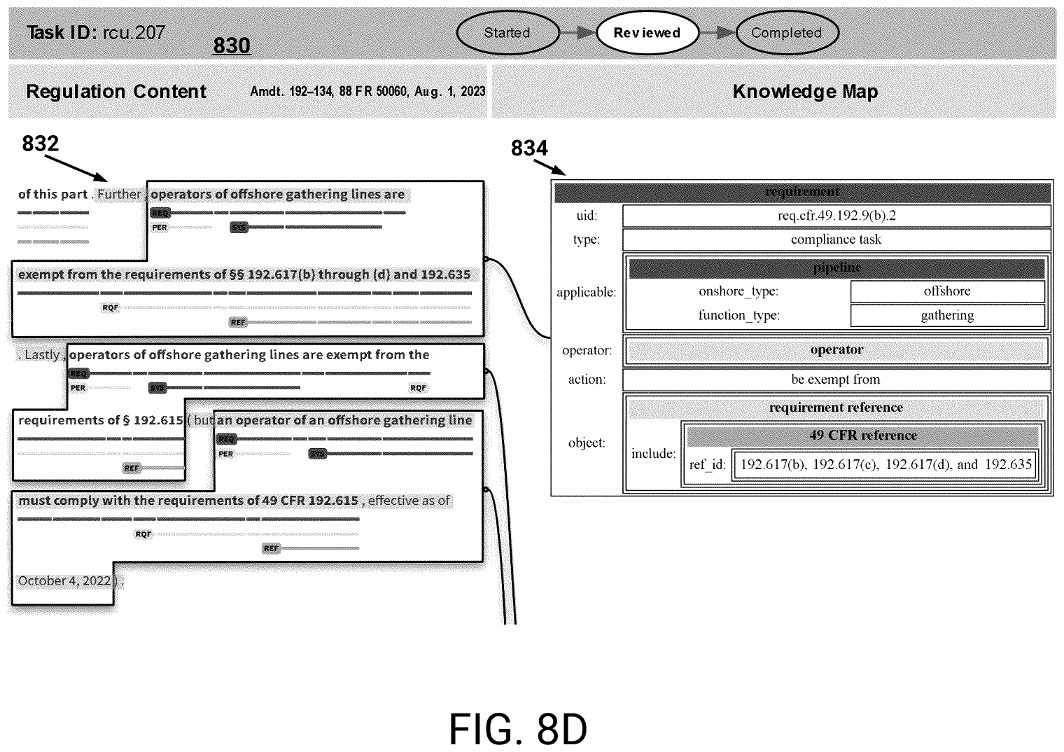

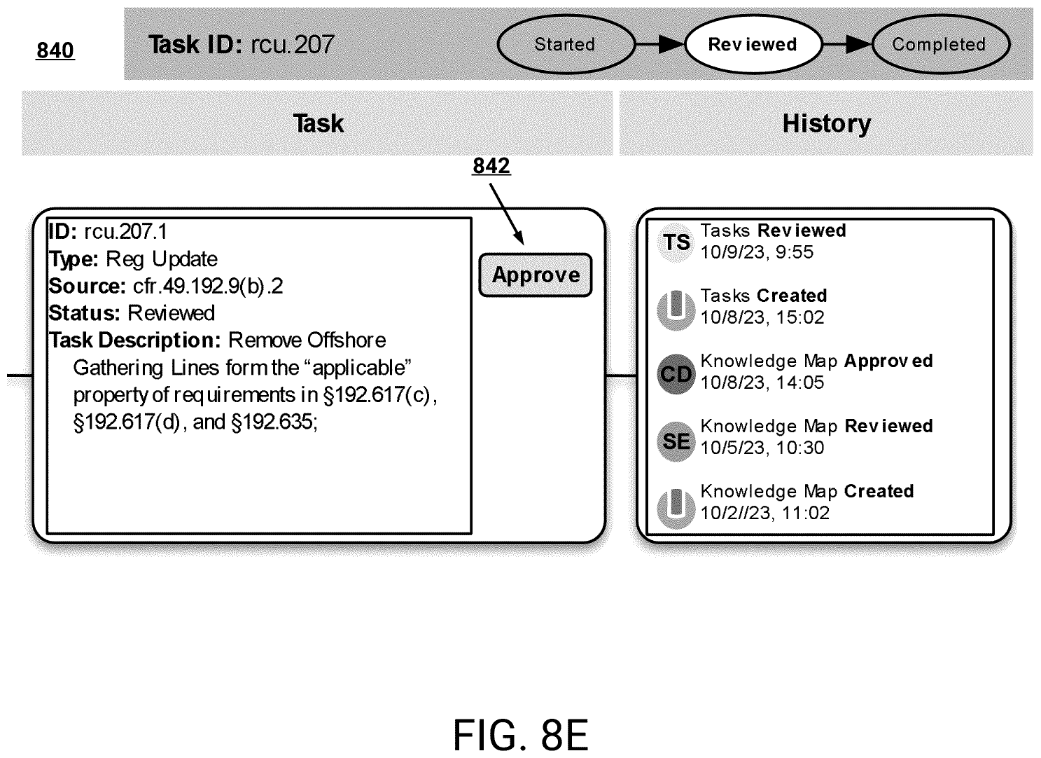

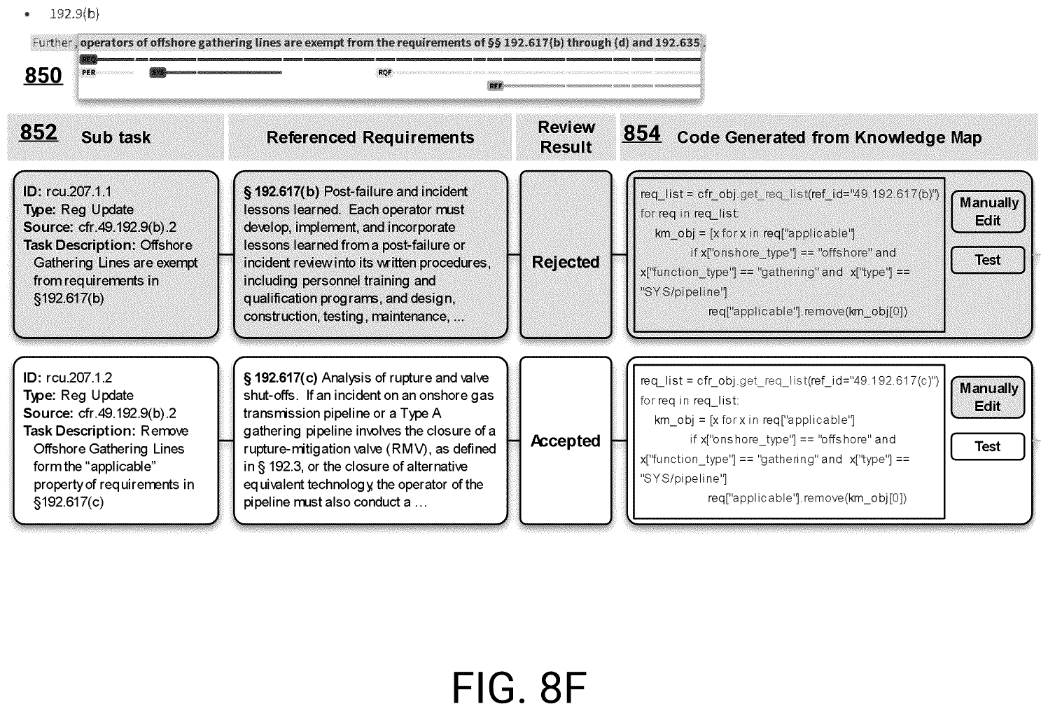

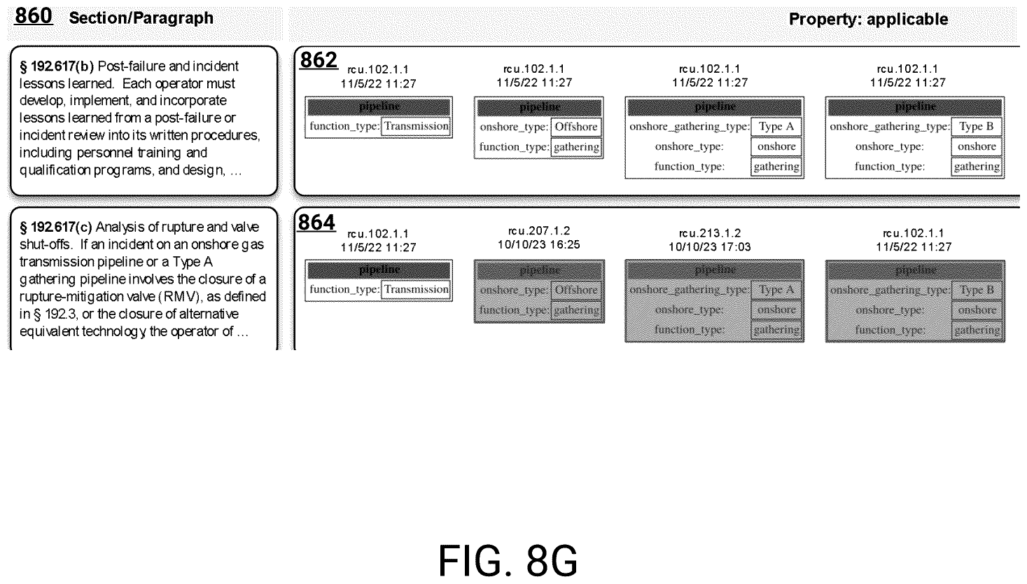

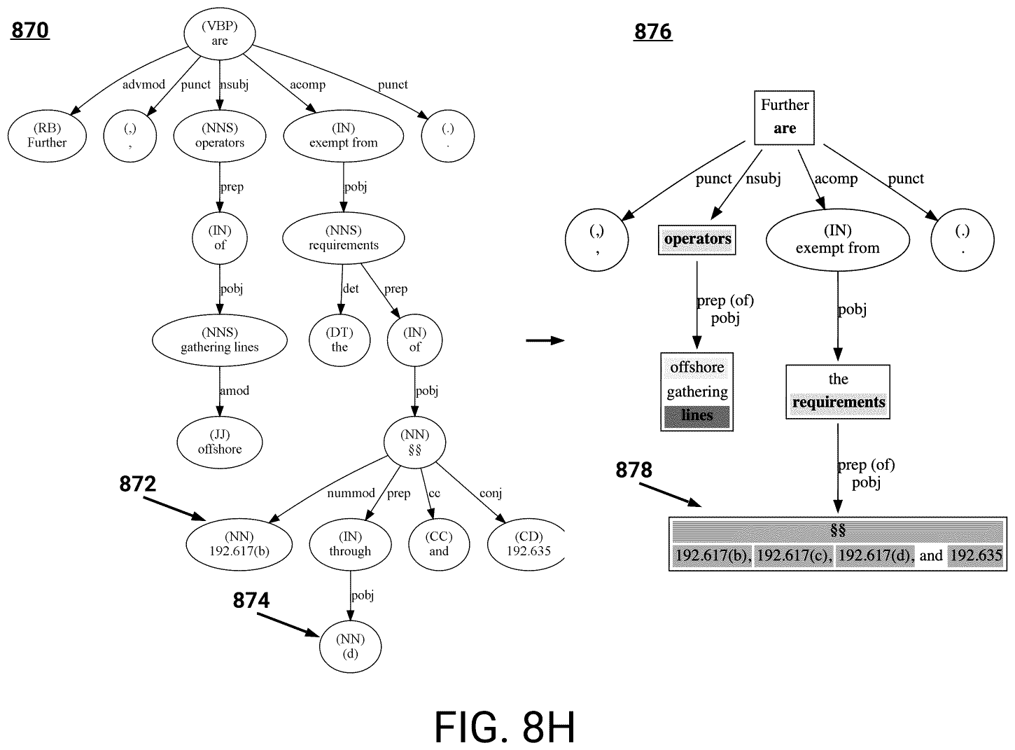

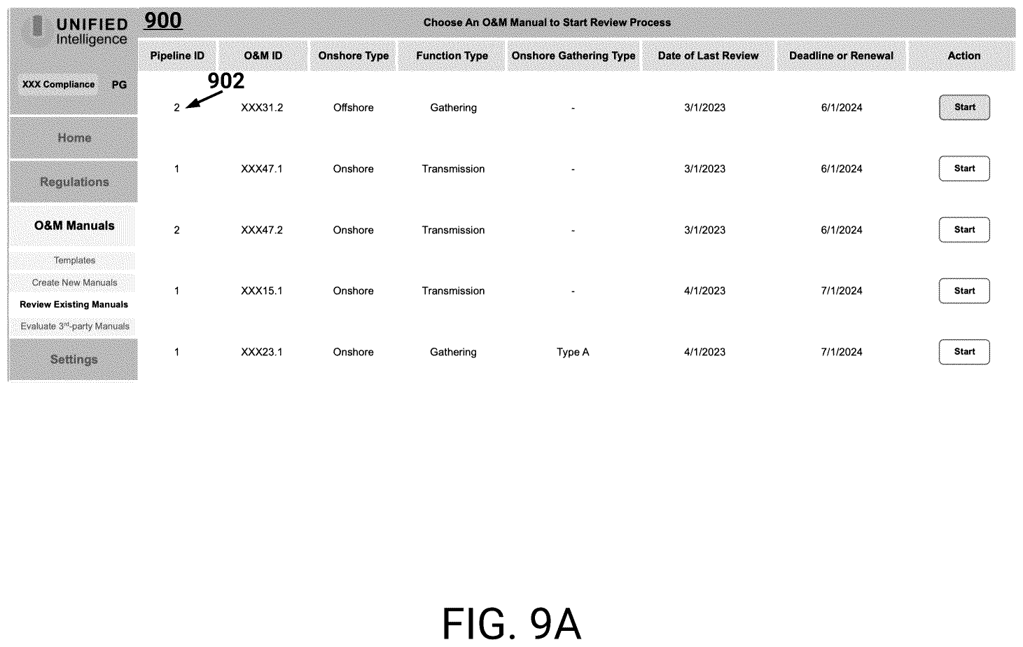

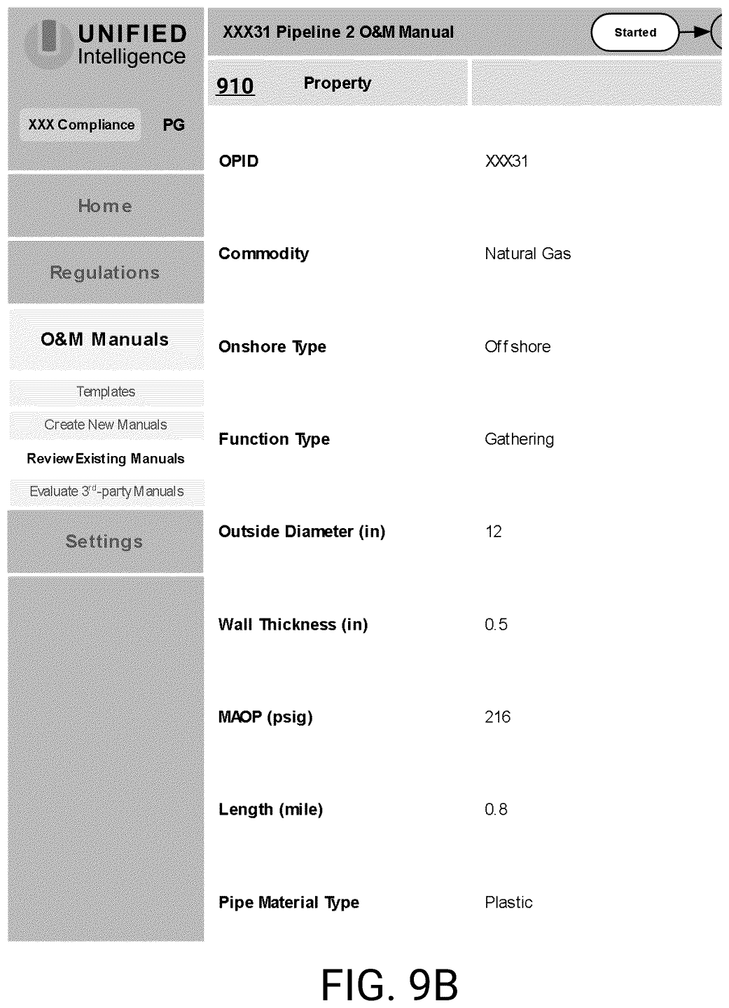

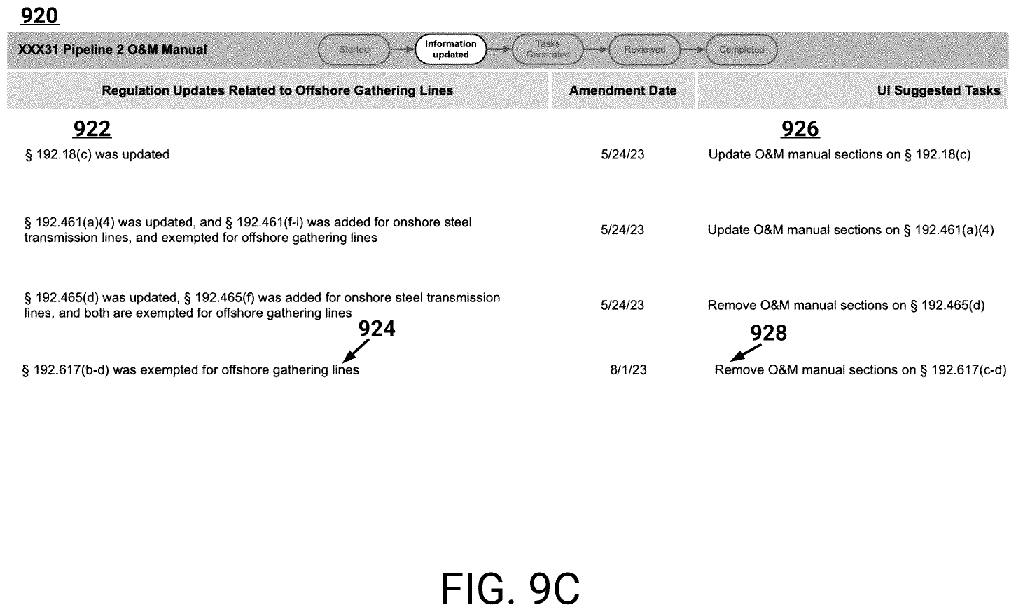

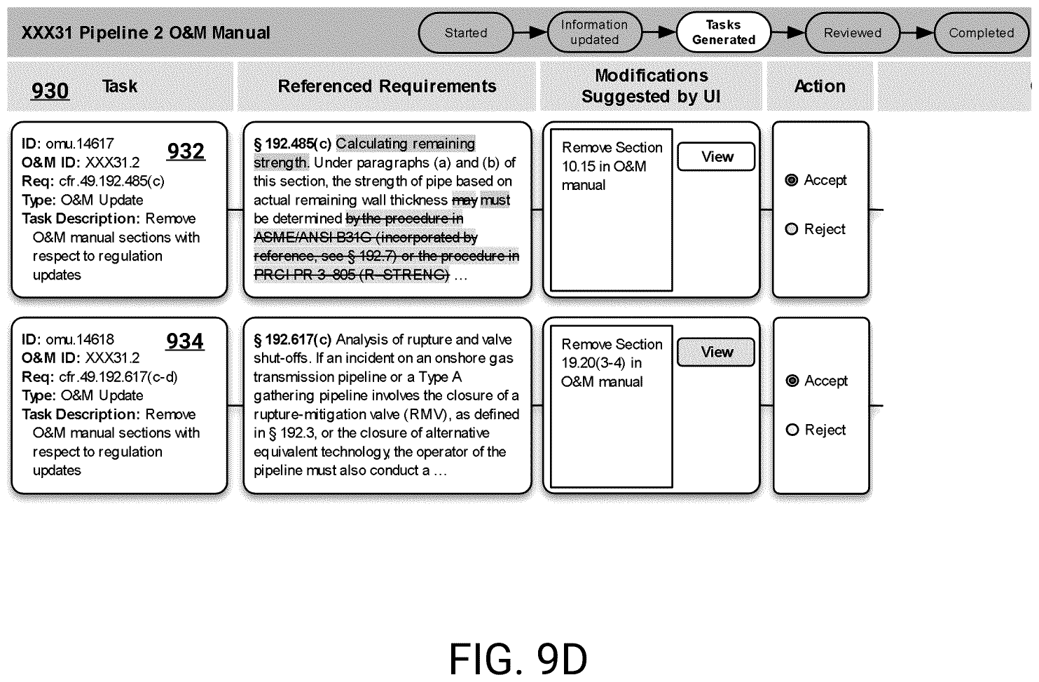

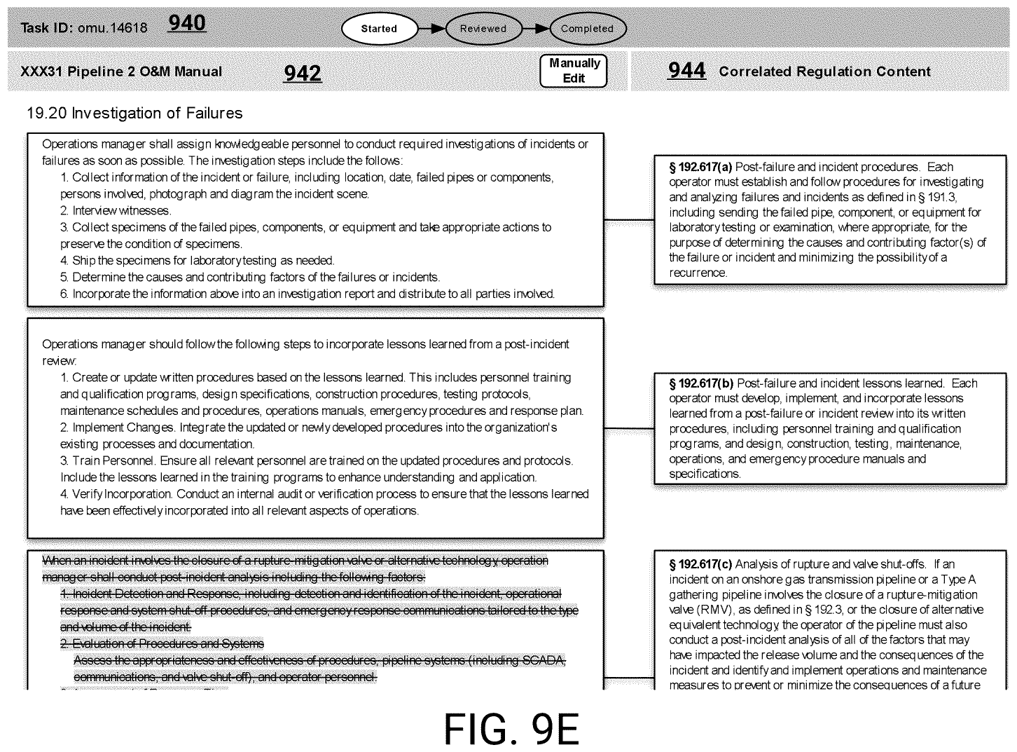

User interface 700 enables access to the system 100, for example the user interface 700 may represent a web application associated with the system 100. The user may log in using, for example, a user identifier and password. As may be appreciated, other techniques to log in may be used (e.g., passkeys, and so on). FIGS. 8A-8G and 9A-E are example user interfaces to which the user may traverse after logging into the system 100.

As will be described, FIGS. 8A-8G include user interfaces associated with reviewing, and optionally revising, changes implicated based on the document 710. For example, the user interfaces may be used to review, and optionally revise, changes to be made to knowledge maps. FIGS. 9A-9E include user interfaces associated with reviewing, and optionally revising, changes to a manual (e.g., an oil and gas manual) prepared based on the document 710. As an example, the manual may summarize how workers are to perform actions, how workers are to connect systems and elements, size constraints on systems and elements, and so on.

FIG. 8A illustrates an example user interface 800 that includes summary information associated with updating manuals. As illustrated, the summary information may include an identification of regulatory codes (e.g., CFR parts) which are being analyzed. The summary information may further include an identification of manuals which are being prepared based on the regulatory codes.

Portion 802 is a user interface element that the user may use to provide a new regulatory code. For example, the user may provide a new version of a regulatory code or a new regulatory code portion. Portion 804 is a user interface element that the user may use to provide a manual for evaluation. For example, the user may provide a manual prepared based on a regulatory code. In this example, the system (e.g., system 100) may analyze the manual in view of the regulatory code. As an example, the system may generate knowledge maps for the manual and regulatory code. The system may then compare the knowledge maps to determine if the manual is in compliance with the regulatory code.

FIG. 8B illustrates an example user interface 810 that includes tasks for completion by a user of the user interface 810. The user interface 810 includes a summary of regulatory codes and whether they are outdated or up-to-date. As may be appreciated, outdated may reflect that a new version of the regulatory code is available and/or has been received by the system. In some embodiments, the text ‘Outdated’ may be assigned a color reflecting whether progress to update to a correspondingly manual has been started. For example, orange may reflect that the process has been started while red may indicate that the process has not yet started. Other visual adjustments may be used and fall within the scope of the disclosure herein. In the illustrated example, the user has selected regulatory code 812 (e.g., 49 CFR 192).

User interface 810 includes an identification of tasks which are associated with updating a manual for regulatory code 812. Each task may reflect one or more changes made to the regulatory code 812. In some embodiments, the user of user interface 810 may select each task and review the changes. The tasks may optionally be assigned by another user, for example a managing user may assign tasks to the user of user interface 810. For example, the other user may review the new version of the CFR and generate tasks associated with updating a corresponding manual.

The tasks may, in some embodiments, be generated by the system. For example, the system may analyze a new version of regulatory code 812. In this example, the system may determine changes implicated by the new version. For example, the system may compare knowledge maps generated from the prior version and the new version of the regulatory code 812. As one example, a portion of the regulatory code 812 may have an entity classified as a task. The task may include properties reflecting that an operator of a pipeline has to perform certain checks after performing an action. Thus, a knowledge map may be generated based on this task. In a new version of the regulatory code 812, the portion may have been updated to remove or add a check. The system may thus generate a knowledge map for the updated portion and compare it to the prior knowledge map. Upon detecting a distinction (e.g., the removal or addition of a check), the system may generate a task.

In FIG. 8B, the user has selected task 814. The example task 814 indicates that it is a regulatory update, and the action indicates that the user is to approve updates. Specifically, task 814 indicates that it relates to 49 CFR 192 (e.g., 49.192.9(b)).

FIG. 8C illustrates an example user interface 820 that includes a first portion of a document as analyzed according to the techniques described herein. User interface 820 may be presented based on user selection of task 814 in FIG. 8B. The user interface 820 includes first portion of 49 CFR 192.9(b), with the text being visually adjusted based on the machine learning techniques described herein.

As an example, different portions of the text are assigned labels based on the natural language processing techniques described above. For this example, an ‘operator’ is identified as an entity and characterized as a person with the sentence 822 reflecting a requirement (e.g., ‘REQ’). The sentence 822 further includes an identification of systems (e.g., SYS) including ‘an offshore gathering line’ and a ‘transmission line.’ The sentence further identifies a requirement reference (e.g., RQF), which as illustrated extends from ‘requirements of this part’ to the CFR portions ending in ‘subpart O of this part’. The sentence identifies the specific reference at issue (e.g., REF) and underlines textual portions which identify the references. For example, ‘subpart O of this part’ is associated with label ‘REF’ and the system may leverage a machine learning model (e.g., as described herein) to identify the reference. Similarly, the portions 192.13(d) through 192.714 are identified as references.

Thus, the user interface 820 includes the text of the regulatory code with visual adjustments based on the machine learning techniques described herein. The system may have generated a knowledge map for sentence 822, and thus the labels may have been assigned as described herein.

FIG. 8D illustrates the example user interface 830 as including a second portion of the document with identified changes made since a prior version of the document. The second portion of the document includes a sentence 832 which has been changed as compared to the prior version of the document. For example, the sentence 832 is highlighted (e.g., in a color, such as green) to reflect that the sentence is new. Text may also be highlighted, crossed out, and so on, to reflect deletions.

Sentence 832 is illustrated with a corresponding knowledge map 834. The system may generate the knowledge map according to the techniques described herein, for example at least in FIG. 1B. The knowledge map 834 identifies a type, which reflect an entity as included in Table 6. The type is a compliance task, which may reflect compliance actions or information. In FIG. 8D, the knowledge map 834 identifies applicable properties which re detected by the system. For example, the properties indicate that task is applicable to offshore gathering pipelines. The properties additionally identify that the task relates to an operator and identifies an action reflecting that the operator is exempt from the action objects. The objects of the action are identified as 192.617(b) through 192.617(d) and 192.635.

Thus, the system has automatically generated a knowledge map based on the newly included sentence 832. As will be described in FIGS. 8F-8G, the user of the user interfaces may review, and optionally adjust, changes implicated by the newly included sentence 832. As may be appreciated, the sentence 832 identifies that operators are exempt from particular requirements of the regulatory code. This change may have consequences which extend beyond the single knowledge map 834. For example, other knowledge maps may reflect operators and the identified requirements. Thus, the system may determine how the knowledge map 834 affects other knowledge maps generated by the system.

FIG. 8E illustrates an example user interface 840 that includes detail associated with a task to update knowledge map(s) generated based on the document. The task may be associated with the sentence 832 of Figure D, for example the task description indicates that ‘offshore gathering lines’ are to be removed from a property of the identified requirements. This reflects that offshore gathering lines are exempt from the identified requirements.

The system may generate the task automatically based on the knowledge map 834 of FIG. 8D. For example, the description may be generated based on parsing the knowledge map 834. In this example, the knowledge map 834 indicates that the property ‘applicable’ is ‘offshore gathering.’ This property may be identified using the techniques described herein, for example applicable may be extracted based on the dependency tree and information tree techniques described at least in FIG. 1B. In this way, the knowledge map 834 indicates that the sentence 834 relates to offshore gathering. The knowledge map 834 further indicates that the knowledge map 834 relates to an operator and has the action ‘exempt from.’ Thus, the system 100 may traverse through the knowledge 834 to form text that describes an outcome of the map 834.

The user of user interface 840 may approve the task via interaction with user interface element 842. Upon selection of the element 842, the user interface 840 may update to present individual sub-tasks. A portion of the sub-tasks are depicted in FIG. 8F.

FIG. 8F illustrates an example user interface 850 that allows the user to accept or reject the sub-tasks. The sub-tasks 852 include a first task that exempts offshore gathering lines from Section 192.617(b). As illustrated in FIG. 8E, a task was generated to exempt offshore gathering lines from 192.617(b)-(d). The sub-tasks 852 therefore separate these exemptions so they can be individually reviewed. The first task indicates exemption from 192.617(b). However, the user of user interface 850 has rejected this exemption. For example, the first sub-task is greyed out and ‘Rejected’ is included. The user may have rejected the exemption for a number of reasons, such as the regulatory code being unclear or potentially incorrect. While the regulatory code, as reflected in sentence 832 of FIG. 8E, did identify Section 192.617(b), the user has decided to maintain the application of this section.

A second task exempts offshore gathering lines from Section 192.617(c). As illustrated, the user has accepted this exemption. The system may generate code, or other information, that causes removal of this section from knowledge map objects that have offshore gathering as an applicable property. For example, the code 854 specifies that knowledge maps which have ‘onshore_type’ equaling offshore and function_type equaling gathering, with the type being a pipeline, are relevant to the section. The user may manually edit the code, or other information, and may optionally perform a test to view results associated with knowledge maps.

FIG. 8G illustrates an example user interface 860 that includes a summary of updates to be made based on the second portion of the document. The user interface 860 includes text from two sections of a regulatory code, Section 192.617(b) and 192.617(c). As described in FIGS. 8A-8F above, these sections are being exempted from operators of offshore gathering lines.

User interface 860 may be used to indicate which applicable properties are affected by the two sections of the regulatory code. For example, the system may identify that transmission, offshore gathering, onshore gathering, and distribution pipelines are relevant to Section 192.617(b). The relevant output is included in portion 862. In this example, the system may analyze knowledge maps with respect to the applicable property.

As illustrated, portion 862 includes the ‘offshore gathering’ pipeline. In sentence 832 of FIG. 8E, offshore gathering was indicated as being exempted from section 192.617(b). However, in FIG. 8G the user rejected this interpretation and maintained this section as being relevant to offshore gathering. In contrast, portion 864 reflects changes made by the sentence 832. For example, offshore gathering is greyed out reflecting that the 617(c) is not relevant to offshore gathering. In this way, the user may quickly ascertain whether the changes made by sentence 832 are properly affecting an understanding of the pipelines.

In FIG. 8A-8G, the user traversed through user interfaces to review, and optionally, modify changes to be made based on an updated regulatory code. The user can then cause updates to be made to a manual to be followed by workers or automated systems of an entity.

FIG. 8H illustrates an example dependency tree 870 and information tree 876 generated based on the sentence 832 of FIG. 8E. The dependency tree 870 may be generated using the techniques described herein, and for example includes a node 872 that identifies a section to be exempt along with another node 874 identifying an ending section (e.g., 192.617(b)-(d). The information tree 876 may be similarly generated using the techniques described herein, and similarly identifies the exempt sections in portion 878.

FIG. 9A illustrates an example user interface 900 reflecting manuals to be updated based on detected changes. In user interface 900, a multitude of manuals are identified. Each manual is associated with different aspects of an entity's operations. For example, manual 902 relates to ‘offshore gathering’. This manual 902 therefore relates to the discussion of FIGS. 8A-8G above, for which a portion of a regulatory code change was described along with its effects. As illustrated, a user of user interface 900 has selected a user interface element (e.g., Start) to review the manual 902.

FIG. 9B illustrates summary information associated with a selected manual. User interface 910 includes detail of the manual selected in user interface 900. For example, the user interface 910 describes that the manual relates to ‘offshore gathering’ and includes parameters of the offshore gathering pipeline (e.g., the outsider diameter is 12 inches).

FIG. 9C illustrates summaries of changes associated with a new version of a document along with suggestions to update the selected manual. In user interface 920, the system has presented updates to regulatory codes which may affect the particular offshore gathering pipeline manual.

User interface 920 includes portion 922 which identifies regulation updates based on analyses of the regulatory codes. As illustrated, one of the updates 924 relates to exemption of 192.61 (b-d) for offshore gathering lines. This exemption is described above, with respect to at least sentence 832 of FIG. 8E.

As described in FIG. 8G, a user rejected the exemption of 192.617(b). Portion 926 of the user interface 920 includes suggested tasks. As illustrated, update 928 indicates removal of sections 192.617(c-d) and not 192.617(b). Thus, the system has used the rejection of 192.617(b) to not include removal of this section as a suggested task.

FIG. 9D illustrates detail associated with specific tasks to update the selected manual. User interface 930 includes tasks associated with updating the offshore gathering manual. Task 932 indicates that the task is to remove particular sections and includes the adjustments to regulatory code 192.485(c). For example, this regulatory code may have a new version and the system is presenting the changes (e.g., the system may highlight additions, such as in green, and deletions, such as in red, optionally with the deletions crossed out).

Task 934 indicates removal of manual sections that relate to 192.617(c-d). Similar to task 934, the user interface 930 is presenting the text from 192.617(c-d) for ease of reader understanding. In portion 936, the user interface 930 is noting that particular sections of the offshore gathering manual (e.g., sections 19.20(3-4)) are to be removed.

FIG. 9E illustrates specific changes to be made to the selected manual based on a selected task. The user interface 940 may be presented upon selection of the task 934. As illustrated, the user interface 940 includes manual text 942 from the offshore gathering manual along with the regulatory code text 944. A recommended change (e.g., deletions of portions of the manual text 942) are included.

The system may identify relevant sections of the manual for adjustment based on, for example, comparisons of knowledge maps between the manual and the regulatory code. As an example, the system may determine measures of similarity between knowledge maps for the manual and knowledge maps generated based on the regulatory code. In the illustrated example, the manual relates to investigation of failures. Similarly, 192.617 relates to “investigating and analyzing failures.” Thus, the system may determine that this portion of the manual is likely related to 192.617. Additionally, the system may recommend deleting the text from manual text 942 based on identifying text from 192.617(c) and 192.617(d). The system may compare underlying knowledge maps or compare the text itself with measures of similarity. In some embodiments, links or associations between portions of a manual and regulatory codes may be, at least in part, manually created. The system may therefore access this information to identify portions of a manual to change.

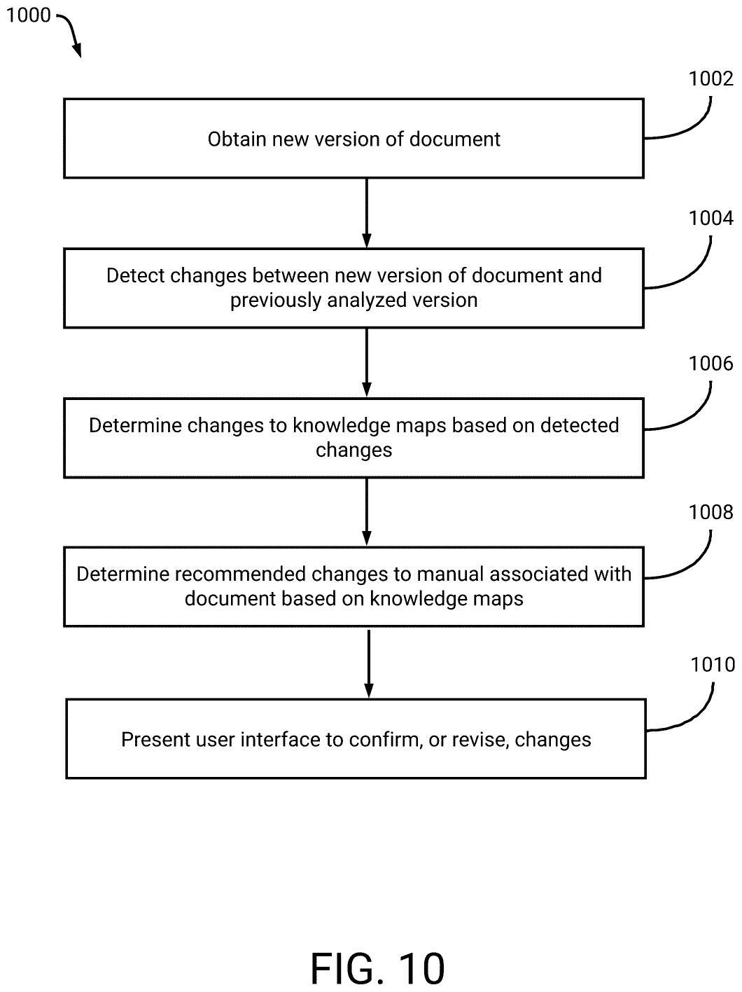

FIG. 10 is a flowchart of an example process 1000 for effectuating changes to a manual associated with a document. For convenience, the process 1000 will be described as being performed by a system of one or more computers (e.g., the knowledge extraction system 100).

At block 1002, the system obtains a new version of a document. As described above, the system may have analyzed a particular document, such as a regulatory code, manufacturing process, and so on. A new version may be received or otherwise obtained.

At block 1004, the system detects changes between the new version and the previously analyzed version. Upon receipt, the system may trigger analysis of the document as described above.

At block 1006, the system determines changes to knowledge maps based on the detected changes. As described in FIGS. 8A-8H, the system generates knowledge maps based on the document. For example, the system may generate a knowledge map for each sentence of the document. As another example, the system may generate a knowledge map for logical groupings of text or sentences. As another example, the system may generate updated knowledge maps for textual portions which have changed since the previously obtained version.

The system thus generates updated knowledge maps. Based on these knowledge maps, the system determines changes to be propagated. For example, and as illustrated in FIG. 8D, an updated knowledge map indicates that certain regulatory sections are exempt from a particular type of entity (e.g., a pipeline having applicable properties, offshore gathering). As described in FIGS. 8E-8F, the system traverses through knowledge maps and identifies changes. With respect to the example of offshore gathering pipelines, the system identifies knowledge maps with knowledge map nodes identifying offshore gathering pipelines. The system then removes reference to the regulatory sections (e.g., from the requirement reference portion).

At block 1008, the system determines recommended changes to a manual associated with the document. The system identifies portions of a manual which are implicated by the detected changes. For example, the system may compare knowledge maps generated based on the manual and the new version of the document. In this example, the system identifies portions of the manual which requires updating. As another example, the system may compare association information (e.g., generated by a user(s)) between portions of the manual and the document. The system then effectuates the changes. For example, the system may remove portions of text or update portions of text (e.g., add text) based on the detected changes. An example of recommended changes is described above with respect to FIGS. 9A-9E.

At block 1010, the system presents a user interface to confirm, or revise, the changes. As described in FIGS. 8A-9E, a user may review changes to be made to knowledge maps and/or the manual. The user may confirm these changes or optionally revise them. For example, in FIG. 8F the user rejected a change with respect to a sub-task.

### OTHER EMBODIMENTS

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1-86. (canceled)

87. A method implemented by a system of one or more processors, the method comprising:
obtaining a textual portion to be analyzed, the textual portion reflecting an updated version of a previously analyzed textual portion, wherein individual changes are detected between the updated version and the previously analyzed textual portion, and wherein the textual portion identifies properties associated with individual entities;
generating one or more knowledge maps based on the detected changes, wherein the knowledge maps are generated based on natural language processing, and wherein the knowledge maps organize the properties associated with individual entities; and
causing presentation of an interactive user interface, wherein the interactive user interface presents changes to a manual associated with the textual portion, and wherein the interactive user interface responds to user input associated with confirming, or revising, the presented changes.

88. The method of claim 87, wherein the textual portion is included in a regulatory code.

89. The method of claim 87, wherein the textual portion is obtained based on monitoring a network location.

90. The method of claim 87, wherein a first knowledge map is generated on a subset of the detected changes, and wherein the first knowledge map indicates removal or inclusion of particular requirements associated with an entity.

91. The method of claim 90, wherein at least a subset of remaining knowledge maps are adjusted based on the first knowledge map, and wherein the adjustment removes or includes the particular requirements for knowledge maps associated with the entity.

92. The method of claim 87, further comprising:
identifying an association between a first knowledge map and a first portion of the manual; and
determining a change to the first portion based on the first knowledge map.

93. The method of claim 92, wherein the association is based on comparisons between knowledge maps generated based on the manual and knowledge maps generated based on the textual portion.

94. The method of claim 92, wherein the association is based on user-defined information mapping, or otherwise associating, the textual portion and the manual.

95. The method of claim 87, wherein the interactive user interface enables revision of the generated one or more knowledge maps.

96. The method of claim 87, wherein the interactive user interface enables revision of effects of the detected changes.

97. The method of claim 87, wherein the interactive user interface enables custom modification of the manual.

98. A system comprising one or more processors and non-transitory computer storage media storing instructions that when executed by the one or more processors, cause the one or more processors to perform operations comprising:
obtaining a textual portion to be analyzed, the textual portion reflecting an updated version of a previously analyzed textual portion, wherein individual changes are detected between the updated version and the previously analyzed textual portion, and wherein the textual portion identifies properties associated with individual entities;
generating one or more knowledge maps based on the detected changes, wherein the knowledge maps are generated based on natural language processing, and wherein the knowledge maps organize the properties associated with individual entities; and
causing presentation of an interactive user interface, wherein the interactive user interface presents changes to a manual associated with the textual portion, and wherein the interactive user interface responds to user input associated with confirming, or revising, the presented changes.

99. (canceled)

100. The system of claim 98, wherein the textual portion is obtained based on monitoring a network location.

101. The system of claim 98, wherein a first knowledge map is generated on a subset of the detected changes, and wherein the first knowledge map indicates removal or inclusion of particular requirements associated with an entity.

102. The system of claim 101, wherein at least a subset of remaining knowledge maps are adjusted based on the first knowledge map, and wherein the adjustment removes or includes the particular requirements for knowledge maps associated with the entity.

103. The system of claim 98, wherein the operations further comprise:
identifying an association between a first knowledge map and a first portion of the manual; and
determining a change to the first portion based on the first knowledge map.

104. The system of claim 103, wherein the association is based on comparisons between knowledge maps generated based on the manual and knowledge maps generated based on the textual portion.

105. The system of claim 103, wherein the association is based on user-defined information mapping, or otherwise associating, the textual portion and the manual.

106. The system of claim 98, wherein the interactive user interface enables one or more of revision of the generated one or more knowledge map, revision of effects of the detected changes, or custom modification of the manual.

107. (canceled)

108. (canceled)

109. Non-transitory computer storage media storing instructions that when executed by a system of one or more processors, cause the one or more processors to perform operations comprising:
obtaining a textual portion to be analyzed, the textual portion reflecting an updated version of a previously analyzed textual portion, wherein individual changes are detected between the updated version and the previously analyzed textual portion, and wherein the textual portion identifies properties associated with individual entities;
generating one or more knowledge maps based on the detected changes, wherein the knowledge maps are generated based on natural language processing, and wherein the knowledge maps organize the properties associated with individual entities; and
causing presentation of an interactive user interface, wherein the interactive user interface presents changes to a manual associated with the textual portion, and wherein the interactive user interface responds to user input associated with confirming, or revising, the presented changes.

110.-119. (canceled)
